(19) United States
(12) Patent Application Publication
(10) Pub. No.: US 2026/0340392 A1
(43) Pub. Date: Oct. 29, 2026

(54) CLIFFORD PERTURBATION THEORY-BASED ERROR MITIGATION

(71) Applicant: International Business Machines Corporation, Armonk, NY (US)

(72) Inventors: Alberto Baiardi, Horgen (CH); Francesco Tacchino, Adliswil (CH)

(21) Appl. No.: 19/192,926

(22) Filed: Apr. 29, 2025

(51) Int. Cl. G06N 3/084; G06N 10/40

(52) U.S. Cl. CPC G06N 3/084; G06N 10/40

(57) ABSTRACT

Systems/techniques that facilitate Clifford Perturbation Theory-based error mitigation are provided. In various embodiments, a system can comprise a memory that stores computer executable components. In various embodiments, the system can further comprise a processor that executes the computer executable components stored in the memory, wherein the computer executable components can comprise an expansion component that can construct a perturbative series expansion of a noise deconvolution map of a quantum circuit, wherein the noise deconvolution map is a product of an inverse of the quantum circuit and an ideal realization of the quantum circuit. In various aspects, the computer executable components can further comprise a measurement component that can invert noise on an expectation value of an observable measured on the quantum circuit based on the perturbative series expansion.

### BACKGROUND

The subject disclosure relates to quantum computing, and more specifically to Clifford perturbation theory-based error mitigation.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate Clifford perturbation theory-based error mitigation are described.

According to one or more embodiments, a system is provided. In various aspects, the system can comprise a memory that stores computer executable components. In various embodiments, the system can further comprise a processor that executes the computer executable components stored in the memory, wherein the computer executable components can comprise an expansion component that can construct a perturbative series expansion of a noise deconvolution map of a quantum circuit, wherein the noise deconvolution map is a product of an inverse of the quantum circuit and an ideal realization of the quantum circuit. In various aspects, the computer executable components can further comprise a measurement component that can invert noise on an expectation value of an observable measured on the quantum circuit based on the perturbative series expansion.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates Clifford perturbation theory-based error mitigation in accordance with one or more embodiments described herein.

FIG. 2 illustrates another block diagram of an example, non-limiting system that facilitates Clifford perturbation theory-based error mitigation in accordance with one or more embodiments described herein.

FIG. 3 illustrates an example, non-limiting diagram showing Clifford perturbation theory-based error mitigation in accordance with one or more embodiments described herein.

FIG. 4 illustrates an example, non-limiting diagram showing a schematic representation of backpropagation of an observable over a noise deconvolution map in accordance with one or more embodiments described herein.

FIG. 5 illustrates an example, non-limiting diagram showing a Dyson diagram for backpropagation of an observable over a noise deconvolution map in accordance with one or more embodiments described herein.

FIG. 6 illustrates an example, non-limiting diagram of a set of Dyson diagrams for constructing a perturbative series expansion of an expectation value of an observable in accordance with one or more embodiments described herein.

FIG. 7 illustrates an example, non-limiting diagram of a set of Dyson diagrams for constructing a perturbative series expansion of an expectation value of an observable in accordance with one or more embodiments described herein.

FIG. 8 illustrates an example, non-limiting diagram showing indexing a Dyson diagram for constructing a perturbative series expansion of an expectation value of an observable in accordance with one or more embodiments described herein.

FIG. 9 illustrates an example, non-limiting diagram showing the translation of a Dyson diagram into an algebraic expression for constructing a perturbative series expansion of an expectation value of an observable in accordance with one or more embodiments described herein.

FIG. 10 illustrates an example, non-limiting diagram showing recursion-based construction of a perturbative series expansion of an expectation value of an observable using a Dyson diagram in accordance with one or more embodiments described herein.

FIG. 11 illustrates an example of simulation results of Clifford perturbation theory-based error mitigation in accordance with one or more embodiments described herein.

FIG. 12 illustrates a flow diagram of an example, non-limiting computer-implemented method that facilitates Clifford perturbation theory-based error mitigation in accordance with one or more embodiments described herein.

FIGS. 13-16 illustrate flow diagrams of an example, non-limiting computer-implemented methods that facilitate construction of a perturbative series expansion of an expectation value of an observable in accordance with one or more embodiments described herein.

FIG. 17 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to one or more embodiments, a system is provided. In various aspects, the system can comprise a memory that stores computer executable components. In various embodiments, the system can further comprise a processor that executes the computer executable components stored in the memory, wherein the computer executable components can comprise an expansion component that can construct a perturbative series expansion of a noise deconvolution map of a quantum circuit, wherein the noise deconvolution map is a product of an inverse of the quantum circuit and an ideal noiseless realization of the quantum circuit. In various aspects, the computer executable components can further comprise a measurement component that can invert noise on an expectation value of an observable measured on the quantum circuit based on the perturbative series expansion. Such embodiments of the system can provide a number of advantages, including improving accuracy of error mitigation results while reducing classical computational overhead, avoiding quantum computational overhead, improving efficiency of error mitigation of a noisy expectation value.

According to one or more embodiments of the aforementioned system, the quantum circuit can be compiled in terms of Pauli exponential gates, and the noise deconvolution map can be of Pauli or Pauli-Lindblad form. Such embodiments of the system can provide a number of advantages, including enabling exact symbolic decomposition of noise effects and compatibility with analytically tractable operator representations.

According to one or more embodiments of the aforementioned system, the expansion component can construct the perturbative series expansion of the noise deconvolution map using operator backpropogation. Such embodiments of the system can provide a number of advantages, including supporting recursive construction of the map and enabling systematic computation of high-order contributions to the series.

According to one or more embodiments of the aforementioned system, the expansion component can express the noise deconvolution map in a Clifford interaction picture and iteratively expand the noise deconvolution map to obtain the perturbative series expansion. Such embodiments of the system can provide a number of advantages, including enabling efficient construction of the perturbative series expansion and a faster conference of the perturbative series expansion.

According to one or more embodiments of the aforementioned system, the expansion component can construct the perturbative series expansion based on a set of Dyson perturbation diagrams, wherein each diagram of the set of Dyson perturbation diagrams corresponds to a term associated with a particular perturbation order. Such embodiments of the system can provide the advantage of diagrammatic visualization of operator contributions for efficiently constructing a perturbative expansion by perturbation order.

According to one or more embodiments of the aforementioned system, the expansion component can perturbatively rank terms in the perturbative series expansion based on a number of orders of sin² θ, wherein θ is an angle associated with an operation, or a number of Pauli operators applied to the observable in the diagram. Such embodiments of the system can provide a number of advantages, including reducing computational overhead while systematically improving accuracy of the error mitigation results and allowing for adjustable trade-offs between computational cost and precision of error mitigation.

According to one or more embodiments of the aforementioned system, the expansion component can truncate the terms in the perturbative series expansion, wherein truncating the terms comprises: truncating noise terms to a defined perturbative order in noise strength; truncating the terms based on a number of orders of sin^{2k} θ, wherein k denotes a perturbation order; or truncating the terms based on a Pauli generator order. Such embodiments of the system can provide a number of advantages, including reducing computational overhead while improving accuracy of the error mitigation results and allowing for adjustable trade-offs between computational cost and precision of error mitigation.

According to one or more embodiments of the aforementioned system, the expansion component can map the term to the diagram, wherein mapping the term to the diagram comprises: indexing nodes in the ideal realization of the quantum circuit in the noise deconvolution map; indexing nodes in the inverse of the quantum circuit in the noise deconvolution map symmetrically to the nodes in the ideal realization, wherein each node in the noise deconvolution map represents an operation in the quantum circuit; and traversing the nodes to determine a coefficient and an operator of the term. Such embodiments of the system can provide a number of advantages, including enabling efficient construction of the perturbative series expansion and reducing computational overhead.

According to one or more embodiments of the aforementioned system, wherein traversing the nodes to determine the coefficient of the term can comprise: scaling the coefficient based on if a generator corresponding to a node anticommutes with a current value of the observable; scaling the coefficient based on a fidelity of the observable through a noise channel of the node; scaling the term by the coefficient; and adding the term to the perturbative series expansion. Such embodiments of the system can provide a number of advantages, including improving accuracy of error mitigation by incorporating specific quantum circuit structure directly into the expansion.

According to one or more embodiments of the aforementioned system, wherein traversing the nodes to determine the coefficient of the term can comprise: identifying if a first node in the ideal realization of the noise-deconvolution map is non-trivial, wherein a non-trivial node is a node that rescales the observable by the generator corresponding to the node; identifying a second node in the inverse of the quantum circuit of the noise-deconvolution map that is symmetric to the first node, wherein the second node has a same index as the first node; and removing the generator at the first node and the second node if the first node and second node are non-trivial, subject to commutation relations. Such embodiments of the system can provide a number of advantages, including improving accuracy of error mitigation results by enabling efficient construction of the perturbative series expansion.

According to one or more embodiments of the aforementioned system, wherein traversing the nodes to determine the coefficient of the term can comprise: scaling, for trivial nodes where the generator anticommutes with the current value of the observable, the coefficient by cos θ, wherein θ is an angle associated with the operation of the node; scaling, for non-trivial nodes where the generator anticommutes with the current value of the observable, the coefficient by −i sin θ if the node is in the inverse of the quantum circuit of the noise deconvolution map, or by +i sin θ if the node is in the ideal realization of the quantum circuit in the noise-deconvolution map; and updating the current value of the observable based on the generator. Such embodiments of the system can provide a number of advantages, including improving accuracy of error mitigation results by enabling efficient construction of the perturbative series expansion.

According to one or more embodiments of the aforementioned system, the measurement component can measure, on a quantum system, the perturbative series expansion. Such embodiments of the system can provide a number of advantages, including improving accuracy of error mitigation results.

According to one or more embodiments of the aforementioned system, the measurement component can measure an expectation value of the perturbative series expansion of the noise deconvolution map based on Pauli-grouping procedures, classical shadows, or generalized quantum measurement protocols of operators in the perturbative series expansion. Such embodiments of the system can provide a number of advantages, including enabling efficient measurement of the error mitigated expectation value and reducing computational overhead.

In various aspects, the above-described system can be reformulated, reformatted, or otherwise implemented as a computer-implemented method or as a computer program product.

### DEFINITIONS

Pauli Propagation: Pauli Propagation is a class of methods for classically calculating quantum circuit expectation values of Pauli obervables by approximating the Heisenberg representation of a quantum circuit through a truncation of the final observable.

Clifford Perturbation Theory (CPT): CPT is a variant of the Pauli Propagation method where the Heisenberg representation of the circuit is constructed by first expressing the circuit in the Clifford Interaction Picture, by commuting the Clifford gates through the circuit and applying them to the observable, and expanded in powers of sin θᵢ, where θᵢ are the rotation angles associated with the non-Clifford gates of the circuit. The method is maximally efficient for near-Clifford circuits.

Classical shadows: A classical shadow is a classical, quasi-probability representation of a quantum state obtained with appropriate measurement protocols.

Noise deconvolution map: A noise deconvolution map is a circuit obtained by concatenating the inverse of the noisy realization of a given quantum circuit with the quantum circuit itself. For nearly-zero noise, this map converges to the identity.

Quantum systems are inherently prone to noise, causing results of quantum computations to be noisy and prone to errors. Noise is a major limiting factor in utility-scale quantum computations. Error mitigation is an algorithm for mitigating the impact of hardware noise on the calculation on quantum circuits. In other words, error mitigation refers to various techniques designed to reduce the impact of such noise and errors in the quantum computations. Specifically, an error mitigation protocol implements error mitigation techniques to enhance the reliability of the results on noisy quantum hardware by executing modified quantum circuits and/or performing classical post-processing to suppress or compensate for noise effects in the quantum computations.

It is often desirable to use quantum systems to estimate expectation values of observables, as these expectation values are critical for understanding physical properties of a quantum system. By measuring observables (e.g., energy, spin, or other quantum properties) quantum systems can provide insights that are difficult or impossible to obtain with classical methods. Accordingly, due to the inherent noise and errors in quantum computations, error mitigation protocols utilize classical and quantum resources to improve the accuracy of the noisy expectation values resulting from the quantum computations.

However, existing methods for error mitigation can be unreliable for various reasons. Specifically, cancelling noise comes, in general, at an exponential price of the quantum computational cost. Thus, most existing methods become quickly prohibitive. Many existing quantum error mitigation techniques rely on sampling of ensembles of quantum circuits, which incur an exponential quantum computational cost. In these approaches, variations of the target circuit are executed multiple times, each with different noise-influencing parameters or structural modifications. However, these methods require a large number of circuit executions to extrapolate or reconstruct noise-free expectation values. This results in significant quantum resource consumption.

Existing techniques that utilize post-processing approaches to shift the burden of noise mitigation to classical computation also suffer, in general, from large computational overheads. These methods typically involve processing large volumes of data generated by quantum circuits to reverse or mitigate the impact of noise. As a result, the classical computational cost increases significantly, especially when high accuracy is required or when the quantum circuits are large and complex. Additionally, these post-processing techniques often necessitate the evaluation of numerous terms, each corresponding to various noise sources, which can lead to an exponential increase in the computational complexity. Such approaches often require sophisticated algorithms to identify, model, and remove noise contributions, further compounding the overhead.

Additionally, several of the existing techniques rely on broad and generic assumptions regarding circuit architecture (e.g., connectivity and/or topology), input state preparation, noise models, and observables of interest. This prevents such methods from leveraging potentially exploitable structure in the input states or the observable, such as symmetries or sparsity. More specifically, these assumptions often involve idealized conditions that do not account for specific features or constraints of practical quantum hardware or problem instances. As a result, such methods are typically unable to exploit particular structural properties of the circuits, states, or measurements, such as symmetries, conservation laws, or sparsity patterns. This lack of specialization can lead to suboptimal performance, as the techniques do not adapt to or take advantage of redundancies or simplifications inherent in the system.

Consequently, the scaling of existing methods for error mitigation remains prohibitive, limiting their application in practical quantum computing at utility-scale.

The various techniques described herein can help to address or ameliorate various of the above-described technical problems that plague existing techniques for performing error mitigation. In particular, the various embodiments described herein can facilitate backpropagation-based error mitigation, such as CPT-based error mitigation, so as to help solve such technical problems.

Specifically, various embodiments described herein can involve receiving a quantum circuit as input. In various aspects, the quantum circuit can be executed on a quantum system to obtain a noisy expectation value of a target observable. That is, noise introduced by the hardware of the quantum system can affect the accuracy of the expectation value. Thus, the quantum circuit can be considered as a noisy quantum circuit. Accordingly, it can be desirable to mitigate the noise effects on the noisy expectation value to obtain a mitigated expectation value that more closely approximates the ideal (i.e., noise-free) expectation value of the quantum circuit.

Therefore, the various embodiments described herein can invert the noise on the noisy expectation value of the observable based on a perturbative series expansion to obtain the mitigated expectation value. More specifically, the various embodiments described herein can construct the perturbative series expansion of a noise deconvolution map of the noisy quantum circuit. The noise deconvolution map is a circuit constructed by concatenating an inverse of the noisy quantum circuit with an ideal (e.g., noise-free) circuit of the noisy quantum circuit. In other words, the noise deconvolution map is a product of the inverse of the noisy quantum circuit and the ideal realization of the same circuit. Thus, for zero noise, the noise deconvolution map becomes the identity circuit. In any instance, the various embodiments described herein can invert the noise on the noisy expectation value based on the perturbative series expansion of the noise deconvolution map to obtain the mitigated expectation value of the noisy quantum circuit.

As used herein, the term “ideal realization of the quantum circuit” is used interchangeably with “ideal part” or “noiseless part”. Additionally, as used herein, the term “inverse of the quantum circuit” is used interchangeably with “inverse-noisy part”. That is, the noise deconvolution map can be composed of two parts: the inverse-noisy part and the ideal part.

In various embodiments, it can be desirable to limit quantum computational overhead in obtaining the mitigated expectation value of the noisy quantum circuit. Accordingly, the various embodiments described herein can construct the perturbative series expansion of the noise deconvolution map to obtain the mitigated expectation value classically in post-processing, thus limiting quantum computational overhead.

The various embodiments described herein can express the noise deconvolution map in the Clifford Interaction Picture (e.g., a compiled form in which all Clifford quantum operations are commuted through the circuit and applied to the target observable) and iteratively expand it into the perturbative series expansion based on CPT. This results in an operator to be measured with noise dependent weights. Accordingly, the various embodiments described herein can measure the operator resulting from the perturbative series expansion, yielding an estimate of the ideal expectation value up to a defined maximum perturbation order (e.g., a degree of approximation in the perturbative expansion that indicates how many terms are included).

Such embodiments can provide a number of advantages. Particularly, such embodiments can avoid quantum computational overhead by measuring the noise deconvolution map on the noisy quantum circuit. That is, the various embodiments described herein can construct the perturbative series expansion of the noise deconvolution map in classical post-processing and obtain the mitigated expectation value based on the perturbative series expansion without quantum computational overhead. Furthermore, such embodiments do not rely on broad assumptions, enabling a wider applicability of error mitigation. More specifically, the various embodiments described herein can approximate the noise deconvolution map with a low-order CPT expansion for any circuit type. Additionally, the embodiments described herein can improve the accuracy of the mitigated expectation value with reduced overhead. For example, a majority of noise in the noisy expectation value can be inverted at the lowest (i.e., zero) perturbation order. That is, a large fraction of the noise can be inverted by including only the target observable in the perturbative series expansion, which involves significantly less classical computational overhead. Further, the perturbative series expansion exhibits fast convergence with perturbation order. Therefore, for large circuits (e.g., circuit includes hundreds of gates), the various embodiments described herein can efficiently obtain the mitigated expectation value. Thus, the various embodiments described herein can improve the accuracy and efficiency of error mitigation for a noisy quantum circuit with reduced computational overhead.

Accordingly, various embodiments described herein can be considered as concrete technical improvements in error mitigation.

Various embodiments described herein can be employed to use hardware or software to solve problems that are highly technical in nature (e.g., to facilitate CPT-based error mitigation), that are not abstract and that cannot be performed as a set of mental acts by a human. Further, some of the processes performed can be performed by a specialized computer (e.g., quantum systems comprising tangible qubits that can execute or implement quantum circuits).

Neither the human mind nor a human with pen and paper can: electronically access or receive a noisy quantum circuit; electronically execute the noisy quantum circuit on a quantum system; electronically construct a perturbative series expansion of a noise deconvolution map at arbitrary order; or electronically measure the perturbative series expansion. After all, a quantum system is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum system. Neither the human mind, nor a human with pen and paper, can transpile or otherwise manipulate quantum gates or execute quantum gates on physical qubits. Also, the very field of quantum error mitigation is focused on electronically executing or implementing quantum circuits on quantum hardware. Therefore, a computerized tool that can facilitate CPT-based error mitigation is inherently computerized and cannot be implemented in any sensible, practicable, or reasonable way without computers.

In various instances, one or more embodiments described herein can integrate the herein-described teachings into a practical application. As mentioned above, some existing techniques can facilitate error mitigation on a noisy quantum circuit using an ensemble of circuits. Unfortunately, such existing techniques incur large quantum computational overhead. As also mentioned above, other existing techniques perform error mitigation in classical post-processing. However, such existing techniques involve substantial classical computations. Further, as mentioned above, existing methods rely on generic assumptions regarding circuit architecture, input state preparation, noise models, and observables of interest, which can cause exponential scaling costs and result in sub-optimal results. Thus, such other existing techniques nevertheless suffer from various technical problems.

Accordingly, the various embodiments described herein can be considered as solving, addressing, or otherwise ameliorating the technical problems that afflict such existing techniques. In particular, various embodiments described herein can include enabling CPT-based error mitigation of a noisy quantum circuit. More specifically, when given a noisy quantum circuit, various embodiments described herein can invert the noise on a noisy expectation value of an observable in the noisy quantum circuit based on a perturbative series expansion of a noise deconvolution map. The perturbative series expansion can be constructed and measured classically on a quantum circuit. In doing so, the various embodiments described herein can perform error mitigation classically without quantum computational overhead associated with multiple quantum circuit executions. Furthermore, the perturbative series expansion can be constructed up to a defined perturbation order. This can limit the classical computational overhead in obtaining the mitigated expectation value. Thus, by implementing CPT-based error mitigation, various embodiments described herein can facilitate improved error mitigation of a noisy quantum circuit with improved accuracy and reduced overhead than existing techniques. For at least these reasons, various embodiments described herein constitute concrete and tangible technical improvements or technical effects in the field of error mitigation and thus certainly qualify as useful and practical applications of computers.

It should be appreciated that the figures and the herein disclosure describe non-limiting examples of various embodiments. It should further be appreciated that the figures are not necessarily drawn to scale.

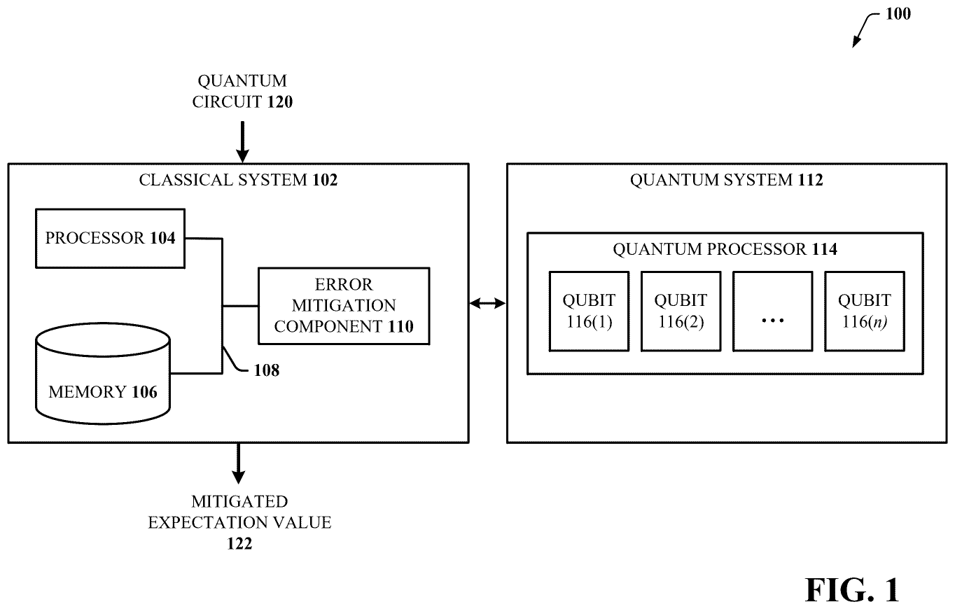

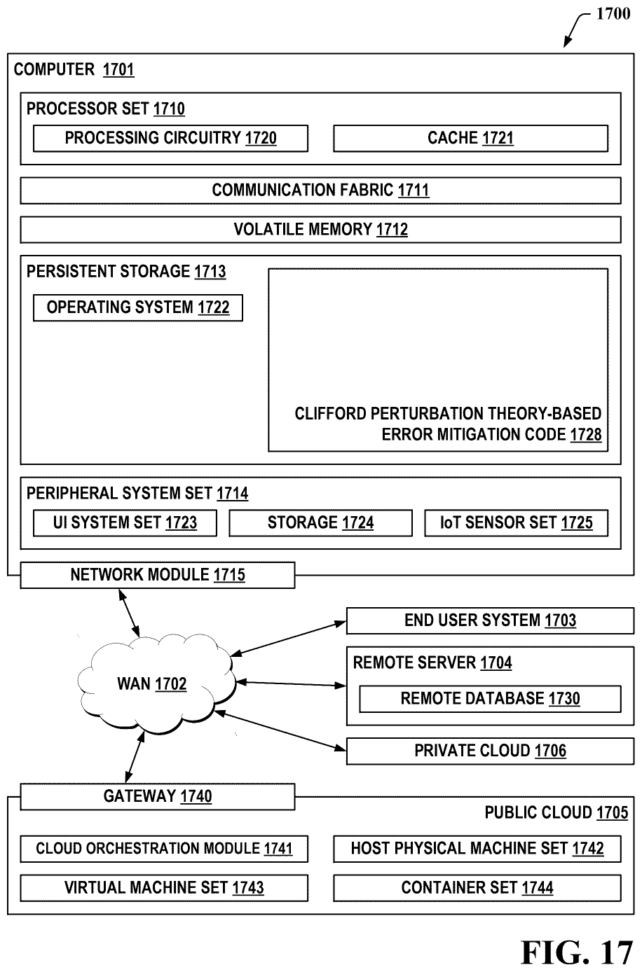

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1700 illustrated at FIG. 17. For example, non-limiting system 100 can be associated with, such as accessible via, a computing environment 1700 described below with reference to FIG. 17 such that aspects of processing can be distributed between non-limiting system 100 and the computing environment 1700. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate CPT-based error mitigation in accordance with one or more embodiments described herein. As shown, a classical system 102 can be electronically integrated, via any suitable wired or wireless electronic connections, with a quantum system 112 or with a quantum circuit 120.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., error mitigation component 110, access component 202, expansion component 204, and/or measurement component 206) to perform one or more actions. In one or more embodiments, memory 106 can store computer-executable components (e.g., error mitigation component 110, access component 202, expansion component 204, and/or measurement component 206).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

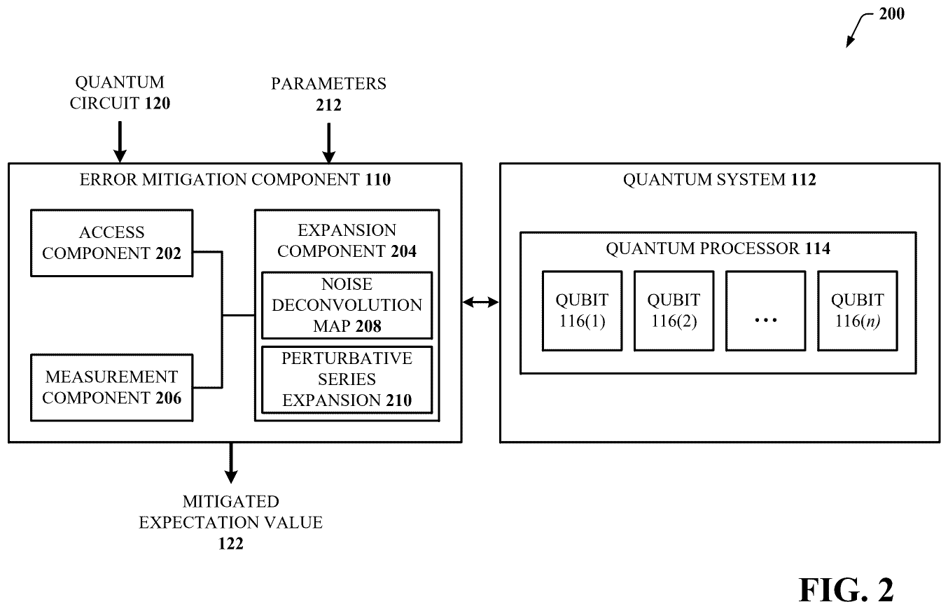

In various embodiments, error mitigation component 110 can comprise access component 202, expansion component 204, and measurement component 206, as illustrated in FIG. 2.

As illustrated in FIG. 1, non-limiting system 100 can comprise classical system 102 and quantum system 112. That is, the non-limiting system 100 can facilitate CPT-based error mitigation, in combination with employment of the quantum system 112. Classical system 102 can be coupled (operatively, communicatively, electrically, and/or like function) to quantum system 112.

In various embodiments, the quantum system 112 can be any suitable quantum computing device or quantum computing hardware. In various aspects, the quantum system 112 can comprise or otherwise include a quantum processor 114. The quantum processor 114 can comprise a set of qubits 116. In various instances, the set of qubits 116 can have n qubits for any suitable positive integer n: a qubit 116(1) to a qubit 116(n). In various cases, any of the set of qubits 116 can exhibit any suitable structure or architecture. As a non-limiting example, any of such qubits can exhibit a superconducting qubit architecture (e.g., such qubit can be constructed from any suitable number of Josephson junctions). As another non-limiting example, any of such qubits can exhibit a quantum dot architecture. As yet another non-limiting example, any of such qubits can exhibit a spin qubit architecture. In various aspects, different qubits of the set of qubits 116 can exhibit the same or different structures or architectures as each other. Although not explicitly shown in FIG. 1, the quantum system 112 can comprise or otherwise be associated with any suitable hardware or software (e.g., real-time controllers implemented in field programmable gate arrays of the quantum system 112) that can be used to initialize any of the set of qubits 116, or that can be used to perform any suitable quantum operations (e.g., quantum gates, qubit measurements, qubit idling) on the set of qubits 116.

In various aspects, the access component 202 can electronically access, in any suitable fashion, the quantum system 112, such that the classical system 102 can electronically activate (e.g., power-up), electronically deactivate (e.g., power-down), or otherwise electronically control the quantum system 112. Furthermore, in various instances, the access component 202 can electronically receive, retrieve, obtain, import, or otherwise access, from any suitable data structures or from any suitable computing devices, the quantum circuit 120. In any case, the access component 202 can electronically access (e.g., send or receive data or program instructions to or from) the quantum system 112 or the noisy quantum circuit 120, such that other components of the classical system 102 can electronically interact with the quantum system 112 or with the quantum circuit 120.

In various instances, the noisy quantum circuit 120 can be any suitable quantum circuit. As opposed to existing methods, the quantum circuit 120 can comprise any suitable circuit structure. In various cases, the measurement component 206 can cause the quantum circuit 120 to be executed or performed on the quantum system 112, thereby producing a noisy expectation value [symbol] O [symbol] noisy of a target observable O. As a non-limiting example, the target observable can be the Pauli-Z operator acting on qubit 116(2).

In various aspects, the expansion component 204 can construct a noise deconvolution map 208 corresponding to the quantum circuit 120. More specifically, the expansion component 204 can express the noise deconvolution map 208 in the Clifford Interaction Picture. To achieve this, the expansion component 204 can commute Clifford gates in the noise deconvolution map 208 through non-Clifford gates in the noise deconvolution map 208, wherein each gate (e.g., operation) is compiled in terms of their generators. That is, each operation has a corresponding generator, wherein the generator is some Pauli operator P. Thereafter, the expansion component 204 can apply the Clifford gates into the target observable (e.g., operator). Thus, the expansion component 204 can iteratively expand the noise deconvolution map 208 into a perturbative series expansion 210, resulting in operator Õ. That is, operator Õ can represent the perturbative series expansion 210. Accordingly, measurement component 206 can measure the resulting operator O to approximate the ideal expectation value [symbol] Ô [symbol] . In various aspects, the expectation value [symbol] O [symbol] can approximate the ideal expectation value [symbol] O [symbol] up to a defined maximum perturbation order. The perturbation order is a degree of approximation that indicates how many terms are included in the perturbative series expansion 210. The resulting expectation value [symbol] O [symbol] can be considered as a mitigated expectation value 122. That is, measuring operator Õ can yield mitigated expectation value 122, where mitigated expectation value 122 corresponds to an estimate of the noise-mitigated form of the noisy expectation value [symbol] O [symbol] _{noisy}.

In various aspects, the perturbative series expansion 210 of the noise deconvolution map 208 can be defined by the following equation:

[symbol] O [symbol] ≈Σₖi^{k}Σⱼ_{₁}_{. . . j}_{ₖ}cⱼ_{₁}_{. . . j}_{ₖ}Tr(ρ_{noisy}Pⱼ_{₁} . . . . Pⱼ_{ₖ}O), where k denotes the perturbation order, Pⱼ_{₁}, . . . , Pⱼ_{ₖ} denotes the operators (e.g., Pauli strings) that generate the gates that appear in the quantum circuit 120 (e.g., the generators corresponding to the operations in quantum circuit 120), Tr(ρ_{noisy}Pⱼ_{₁} . . . . Pⱼ_{ₖ}O) denotes the expectation value of Pauli string Pⱼ_{₁} . . . . Pⱼ_{ₖ}O, cⱼ_{₁}_{. . . j}_{ₖ} denotes the coefficients (e.g., the weight of each expectation value contributing to the ideal observable) in the perturbative series expansion 210, and ρ_{noisy} denotes the quantum state resulting from executing the quantum circuit 120 on the noisy hardware of quantum system 112.

It can be desirable to express the perturbative series expansion 210 of the noise deconvolution map 208 without computing the perturbative series expansion of the ideal circuit, as the latter would imply the quantum circuit 120 is classical simulable. That is, it can be desirable to construct the perturbative series expansion 210 in a way that enables directly mitigating the noisy expectation value [symbol] O [symbol] _{noisy}. As described herein, the classical system 102 can facilitate such construction of the perturbative series expansion 210 of the noise deconvolution map 208 for the noisy quantum circuit 120. Accordingly, the perturbative series expansion 210 that results can be defined by

$$〈 \tilde{O} 〉 = {\sum }_{k = 0}^{N} {\sum }_{{j}_{1} {…j}_{k}} {c}_{{j}_{1} {…j}_{k}} {〈 {P}_{{j}_{1}} {…P}_{{j}_{k}} O 〉}_{noisy} .$$

Thereafter, the measurement component 206 can calculate the expectation value [symbol] O [symbol] by measuring the [symbol] Pⱼ_{₁} . . . Pⱼ_{ₖ}O [symbol] _{noisy} terms and summing them with their noise-dependent weights. Measurement of [symbol] O [symbol] can yield an estimate of the ideal expectation value, i.e. the mitigated expectation value 122, up to the defined maximum perturbation order (e.g., denoted by N).

FIG. 2 illustrates another block diagram of an example, non-limiting system 200 that facilitates CPT-based error mitigation in accordance with one or more embodiments described herein.

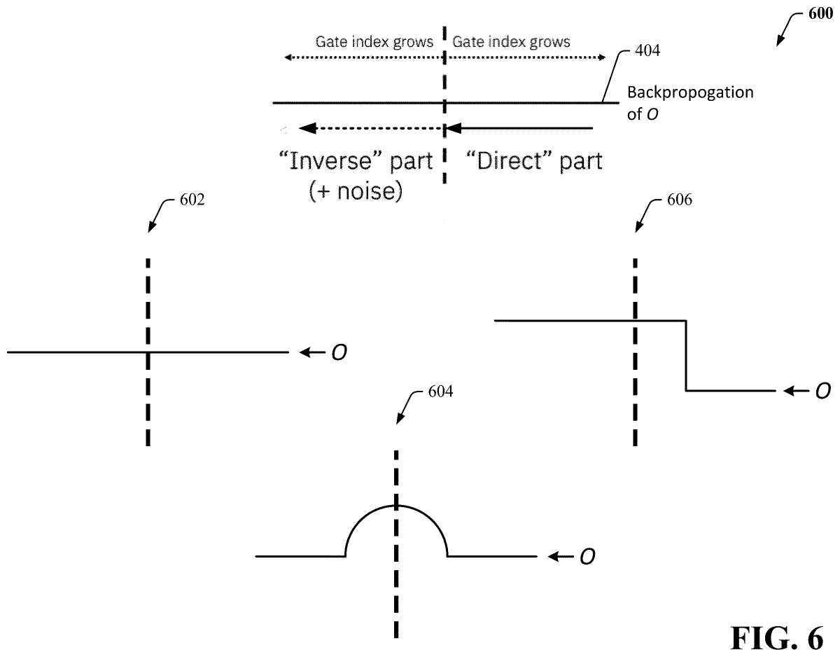

In various embodiments, the expansion component 204 can, as described herein, construct the perturbative series expansion 210 of the noise deconvolution map 208 using a set of Dyson diagrams. A Dyson diagram is a graphical representation used in perturbation theory to visualize contributions (e.g., individual terms at different perturbation orders) in a perturbative series. In various aspects, the expansion component 204 can determine a term to add to the perturbative series expansion 210 at a perturbation order based on a Dyson diagram. That is, the Dyson diagrams can be used to identify the contribution of individual terms to the observable in the perturbative series expansion 210. In various instances, the expansion component 204 can associate a particular Dyson diagram with a term. Thereafter, based on branching of the Dyson diagram (e.g., each branch contributes to a distinct perturbative pathway that modifies the observable) representing the perturbative series expansion 210 of the noise deconvolution map 208, the expansion component 204 can determine a term and a coefficient of a term to add to the perturbative series expansion 210 at a particular perturbation order. Various non-limiting aspects are described with respect to FIGS. 6-11.

In various embodiments, the expansion component 204 can perturbatively rank the terms that can appear in the Dyson diagram representing the perturbative series expansion 210 (e.g., can rank the possible Dyson diagram branching that can appear). In particular, the expansion component 204 can perturbatively rank the terms based on a number of sine expansions (e.g., orders of sin² θ) and a number of Pauli generator orders (e.g., Pauli generator operations) that modify the observable. For example, some Dyson diagrams can have larger contributions than others. Therefore, the expansion component 204 can perturbatively rank the Dyson diagrams to determine which contributions to the given perturbation order to compute first. This can allow for a more accurate mitigated expectation value 122 while maintaining a desired amount of overhead.

In various aspects, the access component 202 can electronically receive, retrieve, obtain, import, or otherwise access, from any suitable data structures or from any suitable computing devices, parameters 212. In various embodiments, the parameters 212 can define any suitable constraints or parameters of the perturbative series expansion 210. As a non-limiting example, the parameters 212 can define the maximum perturbation order of the perturbative series expansion 210. As another non-limiting example, the parameters 212 can define circuit parameters for constructing the perturbative series expansion 210. As still another non-limiting example, the parameters 212 can define a maximum allowable computational overhead. For instance, the parameters 212 can indicate when computation should terminate, such as upon convergence of the perturbative series expansion 210 or once the maximum allowable computational overhead is reached (e.g., can continue computing higher perturbation orders until the maximum allowable computational overhead is reached). In various aspects, parameters 212 can enable user-customized error mitigation by allowing a user to input any desirable constraints or parameters. For example, in cases where limiting overhead is more desirable than accuracy, the user can input a maximum perturbation order.

In various instances, by applying the noise deconvolution map 208 to measurements obtained on the noisy quantum circuit 120, the error mitigation component 110 can reduce the impact of quantum noise on the noisy expectation value. As the perturbation order of the perturbative series expansion 210 increases, the effectiveness of the noise deconvolution map 208 improves, ultimately driving the mitigated expectation value 122 closer to the ideal expectation value by canceling more noise. Specifically, as the perturbation order of the perturbative series expansion 210 increases, additional terms can be included in the perturbative series expansion 210 that can account for more contributions to the observable. Thus, the error mitigation component 110 can be considered as canceling the effect of quantum hardware noise on the noisy expectation value of the observable by applying the noise deconvolution map 208 in classical post-processing. In other words, the error mitigation component 110 can invert the noise on the noisy expectation value, yielding mitigated expectation value 122.

Note that, in various instances, the access component 202, the expansion component 204, and the measurement component 206 can collectively be considered as being error mitigation component 110 of the classical system 102. In various aspects, it should be appreciated that the error mitigation component 110 are described primarily herein as comprising three components (e.g., the access component 202, the expansion component 204, and the measurement component 206) for ease of explanation and illustration. However, the error mitigation component 110 is not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the access component 202, the expansion component 204, and the measurement component 206). In other embodiments, the functionalities described herein of such three components can instead be distributed, separated, split, or fragmented in any suitable fashions, so as to be implemented in or by more than three components (e.g., two or more components can facilitate the functionalities that are performable by the access component 202; two or more components can facilitate the functionalities that are performable by the expansion component 204; two or more components can facilitate the functionalities that are performable by the measurement component 206).

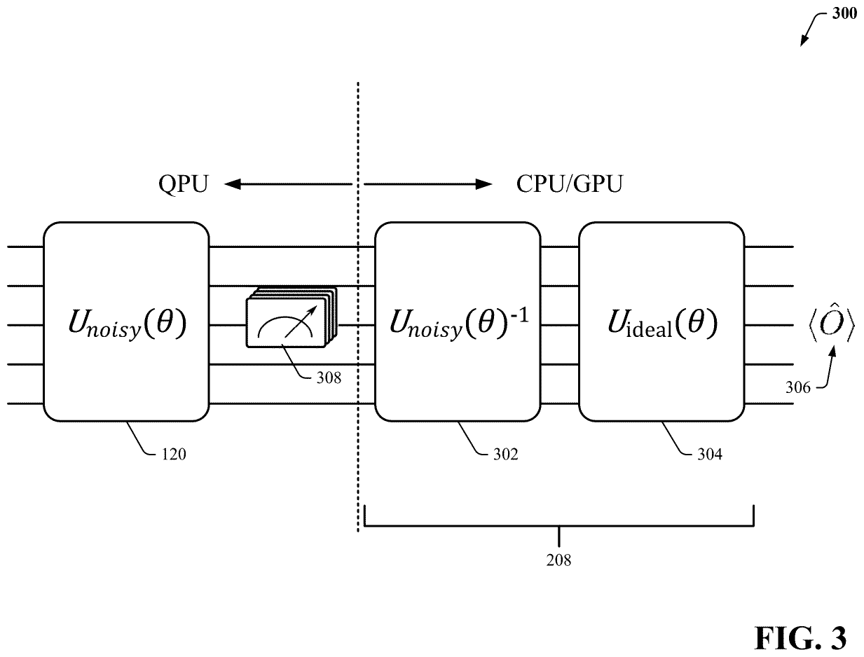

FIG. 3 illustrates an example, non-limiting diagram 300 showing CPT-based error mitigation in accordance with one or more embodiments described herein.

In various aspects, the access component 202 can electronically access the quantum circuit 120, denoted by U_{noisy}(θ) in FIG. 3. The quantum circuit 120 can be considered a noisy quantum circuit as it can be susceptible to noise when performed on the quantum system 112 (e.g., on quantum processor 114). In various embodiments, the measurement component 206 can perform a measurement 308 on the observable, thereby yielding the noisy expectation value of the quantum circuit 120 (e.g., [symbol] O [symbol] _{noisy}).

In various aspects, the measurement component 206 can execute the quantum circuit 120 on the quantum system 112 using any suitable method to convert the noise into a suitable form. For instance, the measurement component 206 can use twirling to convert the noise to Pauli-Lindblad form.

In any case, measurement component 206 can apply the noise deconvolution map 208 in classical post-processing. Specifically, measurement component 206 can apply a product of the inverse of the quantum circuit 302

$$( e . g . , denoted by {U}_{noisy}^{- 1} in FIG . 3 )$$

and an ideal (e.g., noiseless) realization 304 of the quantum circuit (e.g., ideal circuit 304, denoted by U_{ideal} in FIG. 3). By applying the inverse of the quantum circuit 302 and the ideal circuit 304, the noise can be inverted, ultimately resulting in the ideal circuit 304. However, it is not possible to execute the ideal circuit 304. Further, as stated above, it can be desirable to construct the perturbative series expansion 210 such that the perturbative series expansion of the ideal circuit 304, yielding the ideal expectation value 306, denoted by [symbol] O [symbol] , is not being explicitly computed (e.g., since this would imply the quantum circuit 120 is classically simulable). Therefore, the expansion component 204 can construct the perturbative series expansion 210 in an alternative way by deriving terms to include from a set of Dyson diagrams. In other words, the expansion component 204 can express a new observable (e.g., Õ) through the perturbative series expansion 210 that, when evaluated on the noisy quantum circuit, yields the error-mitigated expectation value. In particular, the expansion component 204 can systematically determine which operators (e.g., Pauli operators Pⱼ_{₁}, . . . , Pⱼ_{ₖ}O) contribute more to the ideal expectation value 306, and their respective coefficients cⱼ_{₁}_{. . . j}_{ₖ}. In any instance, the measurement component 206 can measure, on the quantum system 112, the new observable to obtain mitigated expectation value 122. That is, the measurement component 206 can measure an expectation value of the perturbative series expansion 210 of the noise deconvolution map 208. In various instances, the measurement component 206 can measure the expectation value based on Pauli-grouping procedures, classical shadows, or generalized quantum measurement protocols of operators in the perturbative series expansion 210.

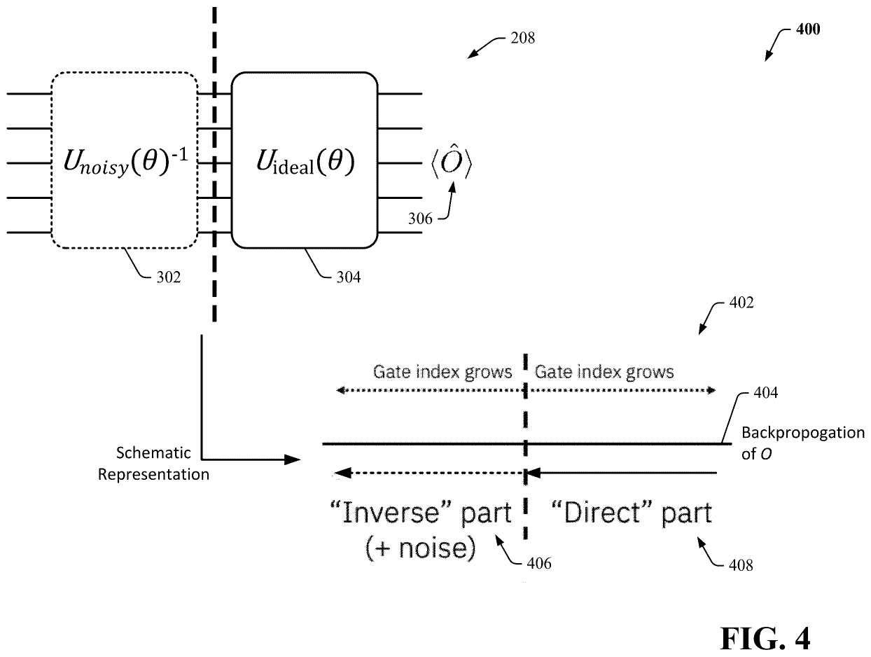

FIG. 4 illustrates an example, non-limiting diagram 400 showing a schematic representation of backpropagation of an observable over a noise deconvolution map in accordance with one or more embodiments described herein.

In various embodiments, the noise deconvolution map 208 can be represented by schematic representation 402. As shown in FIG. 4, the noise deconvolution map 208 can be interpreted as two halves, with the first (e.g., left) half 406 being the inverse of the quantum circuit 302, and the second (e.g., right) half 408 being the ideal circuit 304. In various aspects, the schematic representation 402 depicts a line 404 representing the backpropagation of the observable O through the noise deconvolution map 208.

In various instances, the expansion component 204 can traverse the noise deconvolution map 208 from right to left. In other words, the noise deconvolution map 208 can traverse the observable in the noise deconvolution map 208 starting from the ideal circuit 304 towards the inverse of the quantum circuit 302.

In various aspects, the expansion component 204 can leverage the structure of the noise deconvolution map 208 to group and rank terms that can appear in the perturbative series expansion 210. In particular, the expansion component 204 can leverage CPT during traversal to construct the perturbative series expansion 210 based on the following identities:

### Inverse Pauli Noise Map:

$${ℒ}_{i}^{- 1} [ O ] = ( {\sum }_{s} {( - 1 )}^{〈 {P}_{s} , O 〉} {χ}_{s}^{′} ) O = {C}_{i}^{′ O} O ≃ ( 1 + {ϵ}_{i}^{O} ) O$$

### Propagation Under a Unitary Pauli Gate:

$${e}^{i θ P / 2} O {e}^{- i θ P / 2} = \{ \begin{matrix}O , & [ P , O ] = 0 \\ cos ( θ ) O + i sin ( θ ) PO & \{ P , O \} = 0.\end{matrix}$$

Propagation under inverse Pauli noise if the inverse noise is assumed to apply after the inverse of the ideal gate:

$${ℒ}_{i}^{- 1} {𝒰}_{i}^{- 1} [ O ] = \{ \begin{matrix}{C}_{i}^{O} O , & [ {P}_{i} , O ] = 0 \\ cos ( θ ) {C}_{i}^{O} O - i sin ( θ ) {C}_{i}^{{P}_{i} O} {P}_{i} O & \{ {P}_{i} , O \} = 0.\end{matrix}$$

Propagation under inverse Pauli noise if the inverse noise is assumed to apply before the inverse of the ideal gate:

$${𝒰}_{i}^{- 1} {ℒ}_{i}^{- 1} [ O ] = \{ \begin{matrix}{C}_{i}^{O} O , & [ {P}_{i} , O ] = 0 \\ cos ( θ ) {C}_{i}^{O} O + i sin ( θ ) {C}_{i}^{O} {P}_{i} O & \{ {P}_{i} , O \} = 0\end{matrix} .$$

Note that, as shown above in the propagation under inverse Pauli noise, the inverse noise can be applied before or after the corresponding inverse unitary. The method is applicable in both cases, provided that one is consistent in the order in which the operations are applied, i.e., in setting the appropriate limits in sums and products when associating a numerical coefficient to a diagram. The choice must also be consistent with the noise learning and characterization protocols and their gauge freedom.

Thus, the expansion component 204 can apply the identities to construct the perturbative series expansion 210 as the observable is traversed from right to left in the noise deconvolution map 208.

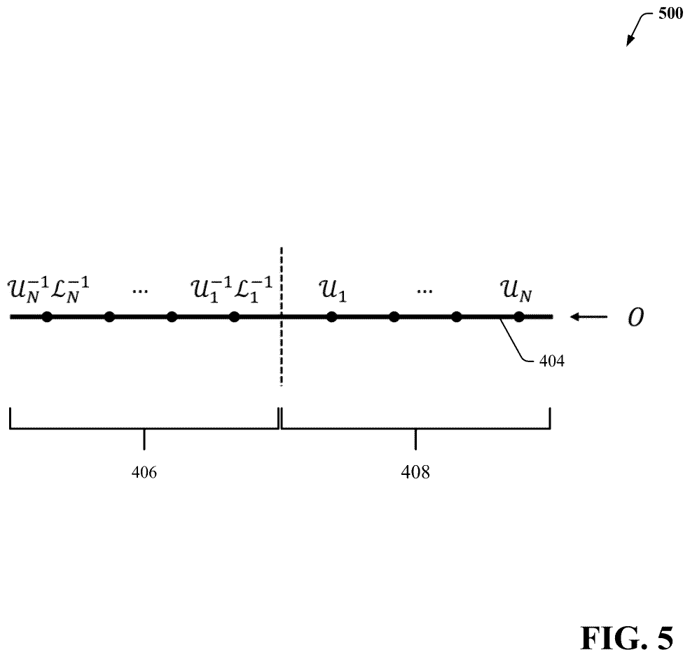

FIG. 5 illustrates an example, non-limiting diagram 500 showing a Dyson diagram for backpropagation of an observable over a noise deconvolution map in accordance with one or more embodiments described herein.

In various aspects, as shown in FIG. 5, the operations of the quantum circuit 120 can be denoted by [symbol] ᵢ and

$${𝒰}_{i}^{- 1} {ℒ}_{i}^{- 1}$$

on line 404 representing the backpropagation of the observable O through noise deconvolution map 208. In particular, the operations in the inverse of the noisy quantum circuit 406 (e.g., left side) can be denoted by

$${𝒰}_{i}^{- 1} {ℒ}_{i}^{- 1} ,$$

and the operations in the ideal circuit 408 can be denoted by [symbol] ᵢ. In various embodiments, the expansion component 204 can traverse such operations from right to left to determine which contributions can appear in the perturbative series expansion 210. Each operation can be represented by a node, where the identities described with respect to FIG. 4 can be applied at each node, resulting in branching through the noise deconvolution map 208. Various non-limiting aspects are described with respect to FIG. 6.

FIG. 6 illustrates an example, non-limiting diagram 600 of a set of Dyson diagrams for constructing a perturbative series expansion of an expectation value of an observable in accordance with one or more embodiments described herein.

In various embodiments, the expansion component 204 can utilize a set of Dyson diagrams to construct the perturbative series expansion 210. In particular, the set of Dyson diagrams can enable determination of what contributions are present in the observable without exploring each branch in the Dyson diagram of the noise deconvolution map 208. That is, applying the identities described with respect to FIG. 4 results in a tree with exponentially many branches through the noise deconvolution map 208. To reduce computational overhead, the expansion component 204 can leverage the set of Dyson diagrams to determine the contributions that are significant and their corresponding terms for constructing the perturbative series expansion 210 without exploring each branch one-by-one. Thus, the expansion component 204 can efficiently construct the perturbative series expansion 210, thereby reducing computational overhead.

In various aspects, each of the set of Dyson diagrams can be associated with a particular term that can appear in the perturbative series expansion 210. For example, the set of Dyson diagrams can comprise diagram 602, diagram 604, and diagram 606.

As shown, diagram 602 is a line diagram, indicating that the observable is never modified through the noise deconvolution map 208. For instance, when a generator commutes with the observable, the observable remains unchanged. In diagram 602, when a generator anticommutes with the observable, all branching points take a cosine route. More specifically, the expansion follows a cos (θ) term rather than a sin (θ) term, resulting in a trajectory that does not alter the observable.

In diagram 604, one branch associated with a generator anticommuting with the observable can take a sine route, creating a PⱼO term that is canceled by its inverse in the inverse-noisy part of the noise-deconvolution map. That is, the inverse of the quantum circuit 302 can take a sine branch at a particular node, while the ideal circuit 304 can pick up the same Pauli operator at a corresponding symmetrical node, thereby resulting in an unchanged observable. Dyson diagrams of this form are referred to herein as “bubble diagrams”.

In diagram 606, one branch can take a sine route, creating a PⱼO term that is not canceled by its inverse. More specifically, when a single branching point, either in the inversenoisy circuit 302 or the ideal circuit 304 of the noise deconvolution map 208, takes the sin θ path, a step is generated, modifying the observable. That is, the observable is modified to PⱼO. Dyson diagrams of this form are referred to herein as “step diagrams”.

In any case, at any point where the observable is modified (e.g., line 404 deviates), the observable becomes PⱼO, indicating that, in the inverse-noisy part of the noise-deconvolution map, noise terms accumulated during the perturbative series expansion are computed not for the original observable O, but for the modified observable PⱼO. This modification ensures that noise factors are properly accounted for in the context of the perturbed observable. Consequently, the noise contributions are computed based on the transformed observable PⱼO.

In various aspects, the branching (e.g., sine or cosine branches) dictate whether the observable is modified or remains unchanged, which directly influences the contributions that need to be accounted for. Conversely, in the step diagram, where the observable is modified to PⱼO, the coefficient corresponding to that contribution will reflect the extent of the modification to the observable, as it tracks the change in the observable through the noise deconvolution map 208. In various embodiments, the expansion component 204 can leverage the Dyson diagrams to determine the coefficients based on the identities applied to the noise deconvolution map 208 and the symmetry of Pauli operators.

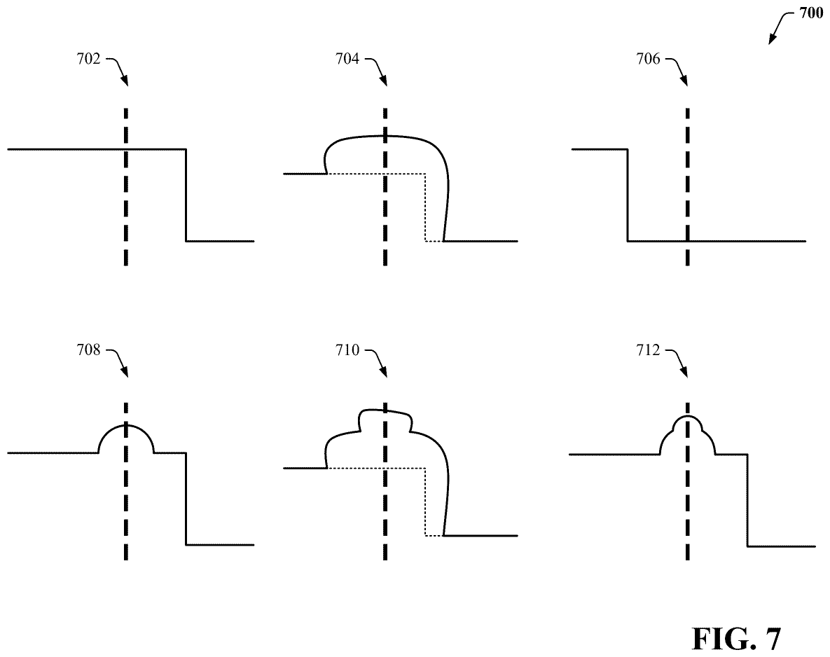

FIG. 7 illustrates an example, non-limiting diagram 700 of a set of Dyson diagrams for constructing a perturbative series expansion of an expectation value of an observable in accordance with one or more embodiments described herein.

Non-limiting diagram 700 illustrates additional example Dyson diagrams at growing Pauli orders. In particular, the additional example Dyson diagrams depicted in FIG. 7 contribute to the [symbol] PⱼO [symbol] _{noisy} branch (e.g., they contain a step). In various aspects, any Dyson diagram in the [symbol] PⱼO [symbol] noisy branch can include any combination of steps and bubbles, enabling more complex branching routes to be represented. For example, as the sin (θₖ)² order increases, diagrams involving multiple bubbles and steps (along with their conjugates) contribute to the [symbol] PⱼO [symbol] _{noisy} branch, provided the bubbles occur symmetrically around the diagram's midpoint. This allows the expansion component 204 to systematically compute higher-order CPT contributions. For any of such Dyson diagrams, the expansion component 204 can determine the appropriate coefficient to apply and identify the corresponding perturbation order to which each diagram contributes.

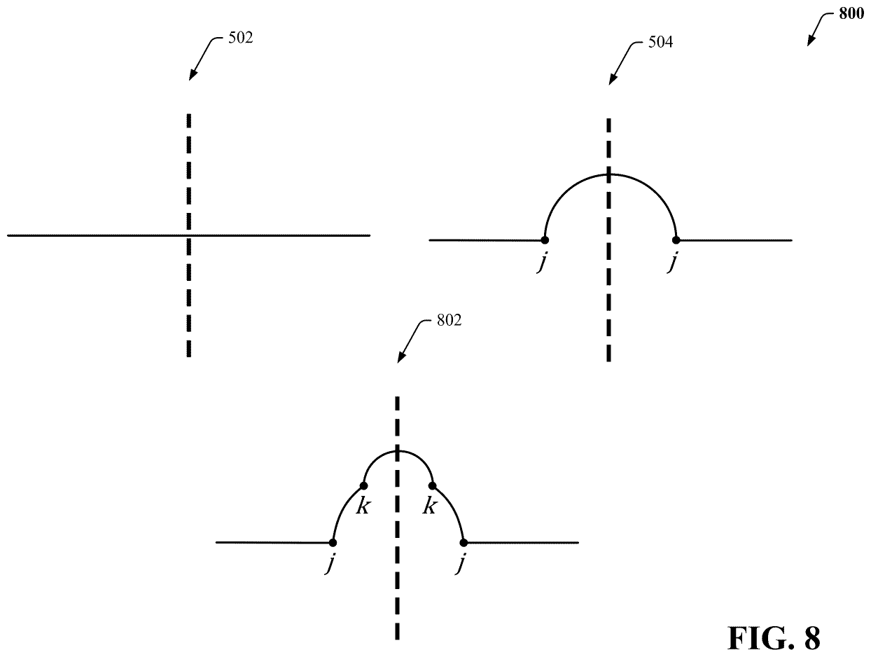

FIG. 8 illustrates an example, non-limiting diagram 800 showing a Dyson diagram for constructing a perturbative series expansion of an expectation value of an observable in accordance with one or more embodiments described herein.

In various embodiments, the expansion component 204 can associate or map a specific contribution to any Dyson diagram. That is, each Dyson diagram can be converted or translated into a corresponding formula that can be used to construct the perturbative series expansion 210.

For example, to perturbation order k=0 (e.g., to the coefficient of [symbol] O [symbol] _{noisy} in the expansion of [symbol] Õ [symbol] ), diagram 602 can be associated with or defined by the following term:

$$[ {\prod }_{{j = 1}_{\{ {P}_{j} , O \}}}^{N} {cos}^{2} {θ}_{j} ] [ {\prod }_{j = 1}^{N} ( 1 + {ϵ}_{j}^{o} ) ] .$$

As another example, diagram 604 can be associated with or defined by the following term:

$${\sum }_{{j = 1}_{\{ {P}_{j} , O \}}}^{N} {sin}^{2} {θ}_{j} {\prod }_{{k = j + 1}_{\{ {P}_{j} , O \}}}^{N} {cos}^{2} {θ}_{k} ] [ {\prod }_{k = j + 1}^{N} ( 1 + {ϵ}_{k}^{O} ) ] [ {\prod }_{{k = 1}_{\{ {P}_{k} , {P}_{j} O \}}}^{j - 1} {cos}^{2} {θ}_{k} ] [ {\prod }_{k = 1}^{j} ( 1 + {ϵ}_{k}^{{P}_{j} O} ) ]$$

As still another example, diagram 802 can be associated with or defined by the following term:

$${\sum }_{{j = 1}_{\{ {P}_{j} , O \}}}^{N} {\sum }_{{k = 1}_{\{ {P}_{k} , {P}_{j} O \}}}^{j - 1} {sin}^{2} {θ}_{j} {sin}^{2} {θ}_{k} [ {\prod }_{{l = j + 1}_{\{ {P}_{l} , O \}}}^{N} {cos}^{2} {θ}_{l} {\prod }_{l = j + 1}^{N} ( 1 + {ϵ}_{l}^{o} ) ] [ {\prod }_{{l = k + 1}_{\{ {P}_{l} , {P}_{j} O \}}}^{j - 1} {cos}^{2} {θ}_{l} {\prod }_{l = k + 1}^{j} ( 1 + {ϵ}_{l}^{{P}_{j} O} ) ] \\ [ {\prod }_{{l = 1}_{\{ {P}_{l} , {P}_{k} , {P}_{j} O \}}}^{k - 1} {cos}^{2} {θ}_{l} {\prod }_{l = 1}^{k} ( 1 + {ϵ}_{l}^{{P}_{k} {P}_{j} O} ) ]$$

In various aspects, the expansion component 204 can perturbatively rank the terms (e.g., rank each Dyson diagram) based on their contribution to the observable. More specifically, the expansion component 204 can rank each term based on the number of “bubbles” (e.g., orders of sin² θ) or the number of “steps” (e.g., Pauli generator orders) in the corresponding Dyson diagram. For example, diagram 604 can have a higher ranking than diagram 802 since diagram 802 comprises two bubbles while diagram 604 comprises one bubble, and therefore comprises a lower order of sin² θ. That is, a higher order of sin² θ indicates a higher perturbation order and therefore a smaller contribution. In any case, based on the ranking of the terms, the measurement component 206 can compute the terms with smaller order (e.g., a higher contribution) first to achieve accurate results while limiting computational overhead. For example, the measurement component 206 can first compute the terms associated with a line diagram (e.g., diagram 602), which corresponds to a zero-order perturbation (i.e., no sine branches taken), and thus contributes the most significantly to the observable. Subsequently, the measurement component 206 can proceed to evaluate diagrams with increasing perturbation order, such as bubble diagrams (e.g., diagram 604) and step diagrams (e.g., diagram 606), each of which introduces additional sine terms and therefore represents increasingly smaller contributions. By prioritizing diagrams with greater perturbative weight (i.e., lower-order sine contributions), the expansion component 204 can ensure that a majority of the noise mitigation effect is captured with minimal computational cost. In various aspects, the accuracy of the series increase as more terms are computed. Such ranking and selective evaluation mechanism can enable efficient approximation of the mitigated expectation value 122 while systematically trading off accuracy against computational resource usage.

In various embodiments, the construct the perturbative series expansion 210 based on the terms determined from the set of Dyson diagrams, the expansion component 204 can truncate each term to first order in noise strength and in the number of sin² θ factors, allowing the perturbative series expansion 210 to be numerically tractable. In other instances, the expansion component 204 can truncate the noise terms to any other defined perturbative order in the noise strength.

As an example, the term associated with diagram 502 can be truncated to the following form:

$$≃ [ 1 + {\prod }_{j = 1}^{N} {ϵ}_{j}^{o} ] [ {\prod }_{{j = 1}_{\{ {P}_{j} , O \}}}^{N} ( 1 - {sin}^{2} {θ}_{j} ) ]$$

As another example, the term associated with diagram 504 can be truncated to the following form:

$$≃ {\sum }_{{j = 1}_{\{ {P}_{j} , O \}}}^{N} [ 1 + {\sum }_{l = 1}^{j} {ϵ}_{l}^{{P}_{j} O} + {\sum }_{l = j + 1}^{N} {ϵ}_{l}^{o} ] {sin}^{2} {θ}_{j} [ 1 - {\sum }_{{k = j + 1}_{\{ {P}_{k} , O}}^{N} {sin}^{2} {θ}_{k} [ 1 - … ] ] [ 1 - {\sum }_{{k = 1}_{\{ {P}_{k} , {P}_{j} O \}}}^{j - 1} {sin}^{2} {θ}_{k} [ 1 - … ] ] .$$

As still another example, the term associated with diagram 802 can be truncated to the following form:

$$≃ {\sum }_{{j = 1}_{\{ {P}_{j} , O \}}}^{N} {\sum }_{{k = 1}_{\{ {P}_{k} , {P}_{j} O \}}}^{j - 1} {sin}^{2} {θ}_{j} {sin}^{2} {θ}_{k} [ 1 + {\sum }_{l = j + 1}^{N} {ϵ}_{l}^{o} + {\sum }_{l = k + 1}^{j} {ϵ}_{l}^{{P}_{j} O} + {\sum }_{l = 1}^{k} {ϵ}_{l}^{{P}_{k} {P}_{j} O} ] [ 1 - … ] [ 1 - … ] [ 1 - … ] .$$

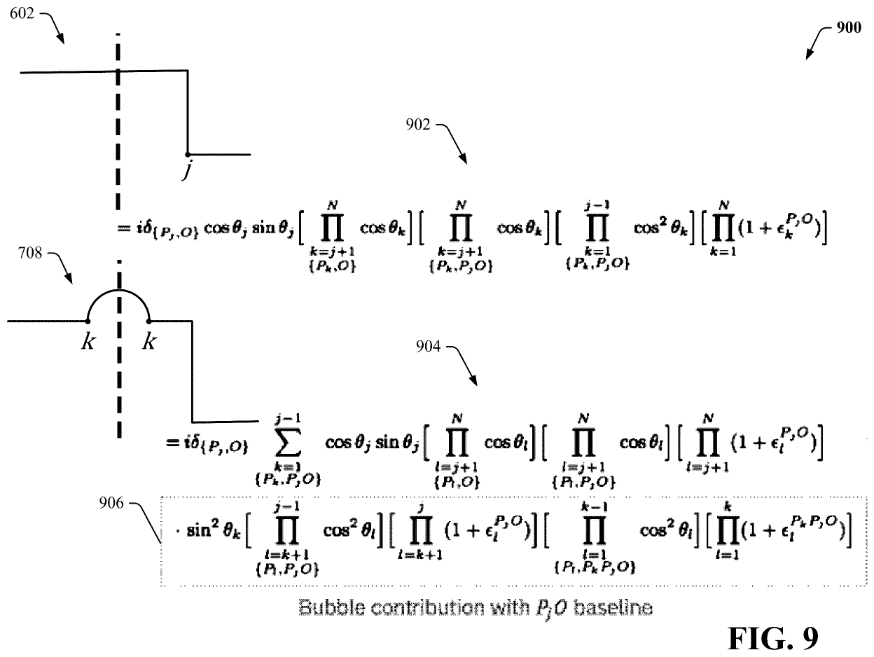

FIG. 9 illustrates an example, non-limiting diagram 900 showing the translation of a Dyson diagram into an algebraic expression constructing a perturbative series expansion of an expectation value of an observable in accordance with one or more embodiments described herein.

Non-limiting diagram 900 depicts additional examples of Dyson diagrams and their associated terms. For instance, diagram 602 can be converted to term 902, and diagram 708 can be converted to 904. As shown, diagram 708 comprises a step and a bubble. Accordingly, the term 904 can comprise term 906 that defines the bubble's contribution to the PⱼO baseline of the observable. Particularly, in the case where a bubble is combined with a step, if it is known how to compute a bubble, the expansion component 204 can rescale the associating term based on the step. Thus, as Dyson diagrams combine steps and bubbles, determining the associating term can become recursive, enabling efficient construction of the perturbative series expansion 210.

In various embodiments, the expansion component 204 can employ a systematic procedure to associate the appropriate term to a Dyson diagram. Such systematic procedure is described below.

First, the expansion component can associate an index j₁, . . . jₖ to each non-trivial node (i.e., whenever a bubble is opened or closed, or a step appears) on either half of the noise deconvolution map 208. Thereafter, the expansion component 204 can associate the same index to a symmetric node on the other half if there is a bubble between them.

Then, the expansion component 204 can initialize a temporary variable A to the observable O. The expansion component 204 can also initialize a coefficient to 1. In various aspects, starting from the right half (e.g., the ideal circuit 304), moving from right to left, each line portion of the diagram contributes a product of cos θₗ from the gates represented by the line, subject to the constraint that {Pₗ, A}=0.

During traversal, for each non-trivial node that is encountered, the expansion component 204 can insert a condition checking that {Pⱼ_{ₖ}, A}=0. Further, if this check is passed, the expansion component 204 can insert a ±i sin θⱼ_{ₖ} term and update A to A←Pⱼ_{ₖ}A. If the non-trivial node is on the left side (e.g., the inverse circuit 302) and represents a closing bubble, the expansion component 204 can commute the generator associated with the operator at the non-trivial node to cancel its copy produced by the bubble opening in the opposite half. More specifically, the expansion component 204 can insert +i sin θⱼ_{ₖ}, if the non-trivial node is on the right half, and −i sin θⱼ_{ₖ} if the non-trivial node is on the left half.

In any case, each line on the left side also contributes a product of

$$( 1 + {ϵ}_{l}^{A} )$$

coefficients for each noise layer represented by the line, using the current value of A. Accordingly, the expansion component 204 can insert the product of

$$( 1 + {ϵ}_{l}^{A} )$$

coefficients into the coefficient.

As a result, the diagram contributes to the [symbol] A [symbol] _{noisy} branch, for A equal to the last value of the temporary variable following traversal of the entire diagram.

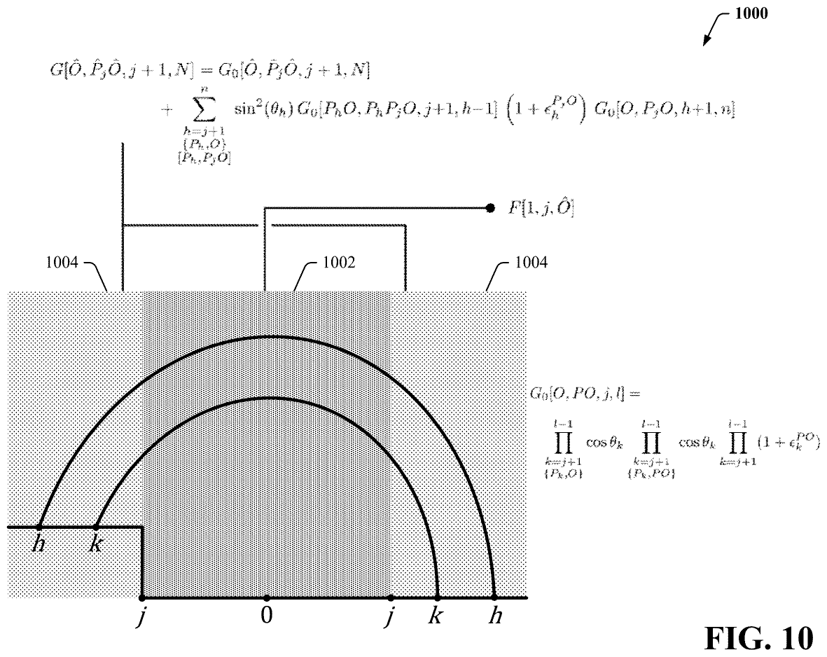

FIG. 10 illustrates an example, non-limiting diagram 1000 showing recursion-based construction of a perturbative series expansion of an expectation value of an observable using a Dyson diagram in accordance with one or more embodiments described herein.

When the operator derived from applying the noise deconvolution map to an observable O includes terms of the form P₁P₂ . . . O, the resulting expansion becomes significantly more complex. This complexity arises from the appearance of many Dyson diagram contributions in the perturbative series expansion 210.

To manage this complexity, the expansion component 204 can recursively construct the perturbative series expansion 210 via a set of recursion formulas derived based on the rules used to construct the Ô branch. For instance, a first-order contribution involving a single step, represented by a Pauli operator PᵢO, can be decomposed into two components: F[1, i, Ô] (0-th order contribution depicted in section 1002 of non-limiting diagram 1000) and G[Ô, \hat{P}ᵢÔ, i+1, N] (first-order term cos (θᵢ) depicted in sections 1004 of non-limiting diagram 1000), where cos (θᵢ) must be explicitly expanded in powers of sin (θᵢ)².

Such recursive approach enables independent evaluation of the bubble and step contributions where the expansion component 204 can subsequently combine the contributions to construct the perturbative series expansion 210 for a given diagram. In any case, via such recursion-based construction, the perturbative series expansion 210 can be constructed at any order.

In various embodiments, the expansion component 204 can compute contributions to the [symbol] O [symbol] _{noisy} branch by summing all Dyson diagrams in which the observable remains unmodified (e.g., where the diagram begins and ends at the same vertical level, indicating that no Pauli operator was applied without cancellation). These diagrams include configurations with zero or more bubble structures (e.g., single, double, or triple bubbles) but exclude steps that would change the observable to PⱼO. The key property of these diagrams is that they feature symmetric application and cancellation of Pauli generators, ensuring the final observable remains O.

In various aspects, each Dyson diagram contributes a term to the perturbative series expansion 210. The perturbative series expansion 210 can be efficiently represented using the following closed-form expression:

$$\tilde{O} = {\sum }_{n = 1}^{N} [ {\sum }_{{j}_{1} = 1}^{N} {\sum }_{{j}_{2} = 1}^{{j}_{1}} … {\sum }_{{j}_{n} = 1}^{{j}_{n - 1}} {sin ( {θ}_{{j}_{1}} )}^{2} … {sin ( {0}_{{j}_{n}} )}^{2} ] {\sum }_{k ∈ j} {( - 1 )}^{k} {E}_{1}^{{k}_{1}} [ {P}_{{k}_{k}} {P}_{{k}_{k - 1}} … {P}_{{k}_{1}} O ] … {E}_{1}^{{k}_{1}} [ O ] {\prod }_{h = 1}^{N} {Δ}_{h}^{k} ,$$

where the functions

$${E}_{{k}_{i}}^{{k}_{i + 1}} [ {P}_{{k}_{i}} … {P}_{{k}_{1}} O ]$$

are the product of the infidelities associated with the circuit noise channels

$${E}_{i}^{j} [ O ] = {\prod }_{h = i}^{j} ( 1 + {ε}_{h}^{O} ) .$$

### The

$${Δ}_{h}^{k}$$

function depends on the anticommutation properties between a given Pauli Pₕ and Pₕ₋₁ Pₕ₋₂ . . . O. The term only appears in the perturbative series expansion 210 if associated (anti) commutation rules are fulfilled.

An advantage of this formalism lies in the bounded nature of θ, which is assumed to be less than π/4 in the Clifford Interaction Picture. This constraint ensures that the sin² θ terms remain small, reinforcing the validity of the perturbative series expansion 210. By summing the Dyson diagrams that do not involve steps, the expansion component 204 isolates the [symbol] O [symbol] _{noisy} branch contributions and can compute their cumulative effect up to a desired perturbation order.

Each of these bubble diagrams contributes a term to the perturbative expansion of the expectation value. These contributions can be efficiently represented using the closed-form expression that aggregates all bubble diagrams up to a given order of sin² θ. Specifically, the sum over perturbation orders N includes a product of sinusoidal functions, with the number of terms in the product corresponding to the order. This ranking mechanism provides a systematic way to prioritize and truncate the expansion based on the significance of each term's contribution, enabling accurate approximations with low computational cost.

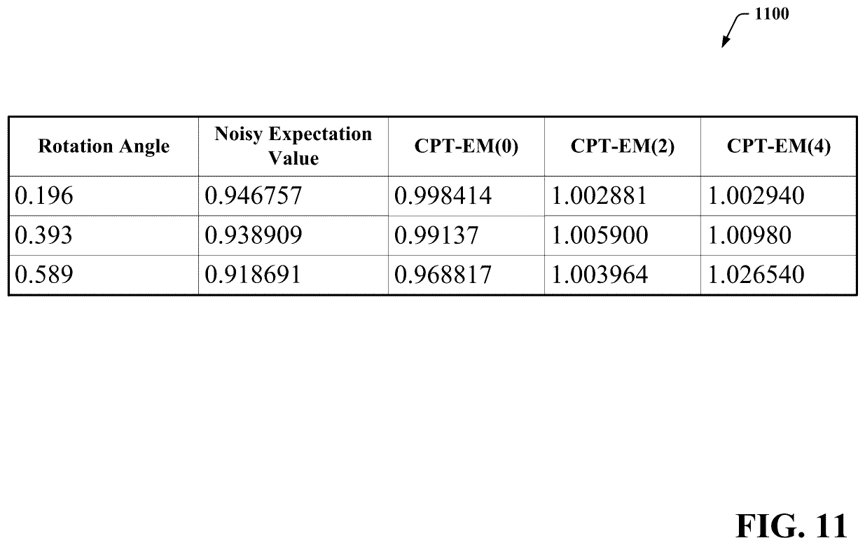

FIG. 11 illustrates an example, non-limiting diagram 1100 of simulation results of CPT-based error mitigation in accordance with one or more embodiments described herein.

The non-limiting diagram 1100 illustrates simulation results of CPT-based error mitigation at different CPT orders (e.g., maximum order in sin (θₖ)²) including only bubble diagrams. In particular, the non-limiting diagram 1100 shows simulation results for a mirrored circuit based on a Trotter on a kicked Ising Hamiltonian, where the circuit is constructed such that a backward propagation is appended to a forward propagation. Thus, in a noiseless case, the circuit is equal to the identity circuit, allowing for an accurate prediction of the ideal expectation value of the observable.

The non-limiting diagram 1100 shows the noisy expectation value and CPT-based error mitigated expectation value of the \hat{Z}_{N} operator (N denotes the number of qubits) at different rotation angles, including only the Ô operator when applying the noise deconvolution map to the operator via the Heisenberg representation. In any case, the ideal expectation value is expected to be 1. As shown, at order 0, the CPT-based error mitigated expectation value is significantly closer to 1 compared to its noisy counterpart, indicating that a majority of the noise effects on the noisy expectation value can be inverted. Furthermore, at order 0, only the original observable is included in the CPT operator, significantly reducing classical computational overhead in the error mitigation. Thus, CPT-based error mitigation can enable accurate error mitigation of the expectation value of the observable with low classical computational overhead. Similarly, at order 2 and order 4, the CPT-based error mitigated expectation value is significantly closer to 1, indicating that CPT-based error mitigation can invert the noise of the noisy expectation value. Moreover, as shown in non-limiting diagram 1100, the CPT-based error mitigated expectation values exhibit fast convergence to 1 with the CPT order. Additionally, convergence of the perturbative series expansion becomes faster the closer the circuit is to being Clifford.

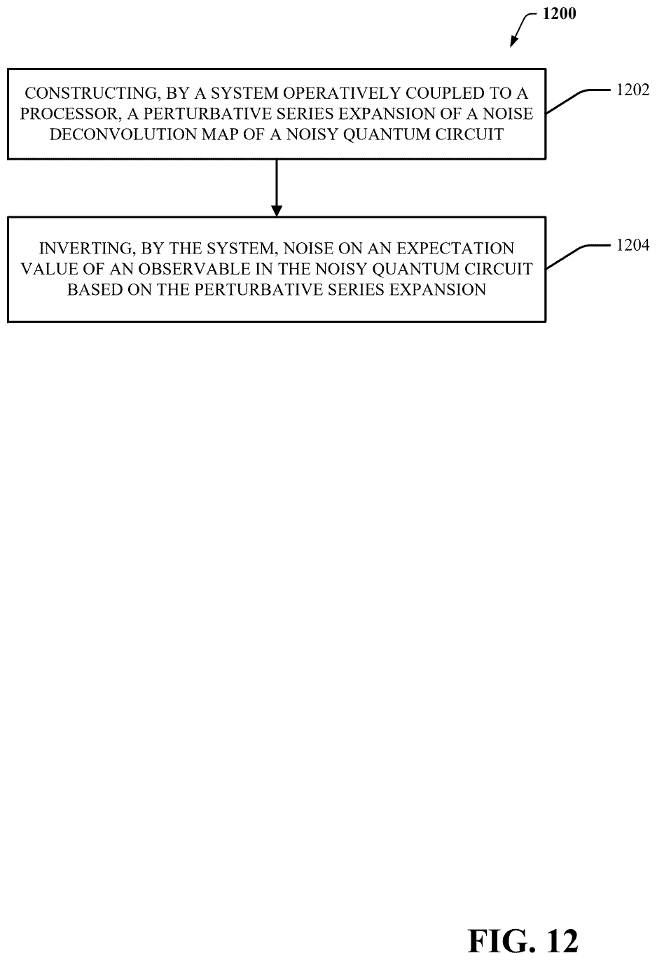

FIG. 12 illustrates a flow diagram of an example, non-limiting computer-implemented method 1200 that can facilitate CPT-based error mitigation in accordance with one or more embodiments described herein. In various cases, the classical system 102 can facilitate the computer-implemented method 1200.

In various embodiments, act 1202 can include constructing, by a system (e.g., via 204) operatively coupled to a processor (e.g., 104), a perturbative series expansion (e.g., 210) of a noise deconvolution map (e.g., 208) of a noisy quantum circuit (e.g., 120).

In various aspects, act 1204 can include inverting, by the system (e.g., via 206), noise on an expectation value (e.g., 306) of an observable in the noisy quantum circuit based on the perturbative series expansion.

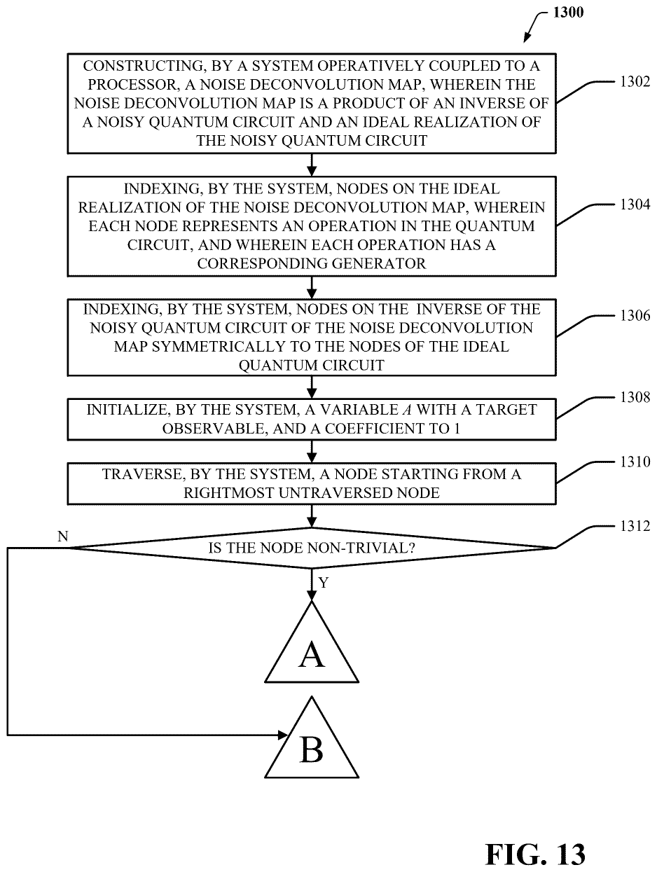

FIGS. 13-16 illustrate flow diagrams of an example, non-limiting computer-implemented methods 1300, 1400, 1500, and 1600 that can facilitate CPT-based error mitigation in accordance with one or more embodiments described herein. In various cases, the classical system 102 can facilitate the computer-implemented method 1100.

In various embodiments, act 1302 can include constructing, by a system (e.g., via 204) operatively coupled to a processor (e.g., 104), a noise deconvolution map (e.g., 208), wherein the noise deconvolution map is a product of an inverse of a noisy quantum circuit (e.g., 302) and an ideal realization of the noisy quantum circuit (e.g., 304).

In various aspects, act 1304 can include indexing, by the system (e.g., via 204), nodes on the ideal part of the noise deconvolution map, wherein each node represents an operation in the quantum circuit, and wherein each operation has a corresponding generator.

In various cases, act 1306 can include indexing, by the system (e.g., via 204), nodes on the inverse of the noisy quantum circuit of the noise deconvolution map symmetrically to the nodes of the ideal circuit.

In various aspects, act 1308 can include initializing, by the system (e.g., via 204), a variable with a target observable, and a coefficient to 1.

In various cases, act 1310 can include traversing, by the system (e.g., via 204), a node starting from a rightmost untraversed node. In other words, the expansion component 204 can traverse the nodes starting from the ideal circuit towards the inverse of the noisy quantum circuit in the noise deconvolution map. In still other words, the expansion component 204 can traverse the nodes from right to left, following the backpropagation of the observable.

In various aspects, act 1312 can include determining if the node is non-trivial. If not (e.g., the node is trivial), the computer-implemented method 1300 can proceed to non-limiting computer-implemented method 1500. If so (e.g., the node is non-trivial), the computer-implemented method 1300 can proceed to non-limiting computer-implemented method 1400. In various aspects, a trivial node is a node such that the operation corresponding to the node does not modify the observable. Conversely, a non-trivial node is a node that modifies the observable by rescaling it by the corresponding generator.

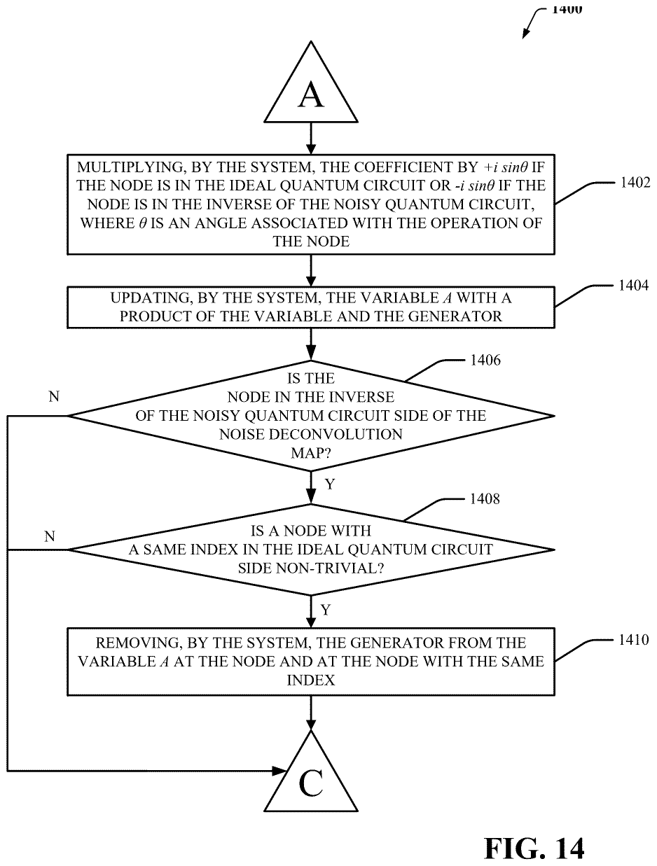

Turning to FIG. 14, in various cases, act 1402 can include determining if the generator associated with the node anticommutes with the variable. If not (e.g., the generator associated with the node does not anticommute with the variable), the coefficient is set to 0, and the computer-implemented method 1400 can proceed to non-limiting computer-implemented method 1600. If so (e.g., the generator associated with the node anticommutes with the variable), the computer-implemented method 1400 can proceed to act 1408.

In various aspects, act 1402 can include multiplying, by the system (e.g., via 204), the coefficient by +i sin θ if the node is in the ideal circuit or −i sin θ if the node is in the inverse of the noisy quantum circuit, where θ is an angle associated with the operation of the node.

In various instances, act 1404 can include updating, by the system (e.g., via 204), the variable with a product of the variable and the generator.

In various cases, act 1406 can include determining, if the node is in the inverse of the noisy quantum circuit side of the noise deconvolution map. If not (e.g., the node is not in the inverse of the noisy quantum circuit side of the noise deconvolution map), the computer-implemented method 1400 can proceed to non-limiting computer-implemented method 1600. If so (e.g., the node is in the inverse of the noisy quantum circuit side of the noise deconvolution map), the computer-implemented method 1400 can proceed to act 1408.

In various cases, act 1408 can include determining, if a node with a same index in the ideal quantum circuit side of the noise deconvolution map is non-trivial. If not (e.g., the node with a same index in the ideal quantum circuit side of the noise deconvolution map is trivial), the computer-implemented method 1400 can proceed to non-limiting computer-implemented method 1600. If so (e.g., the node with a same index in the ideal quantum circuit side of the noise deconvolution map is non-trivial), the computer-implemented method 1400 can proceed to act 1410.

In various embodiments, act 1410 can include removing, by the system (e.g., via 204), the generator from the variable at the node and at the node with the same index. After act 1410, the computer-implemented method 1400 can proceed to non-limiting computer-implemented method 1600.

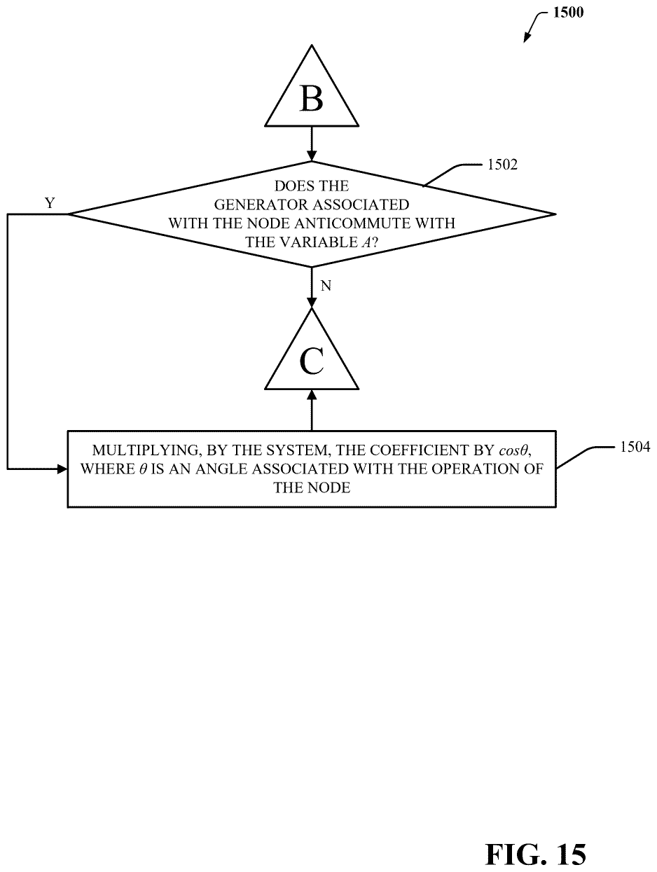

Turning to FIG. 15, in various embodiments, act 1502 can include determining if the generator associated with the node anticommutes with the variable. If not (e.g., the generator associated with the node does not anticommute with the variable), the computer-implemented method 1500 can proceed to non-limiting computer-implemented method 1600. If so (e.g., the generator associated with the node anticommutes with the variable), the computer-implemented method 1500 can proceed to act 1504.

In various aspects, act 1504 can include multiplying, by the system (e.g., via 204), the coefficient by cos θ, where θ is an angle associated with the operation of the node.

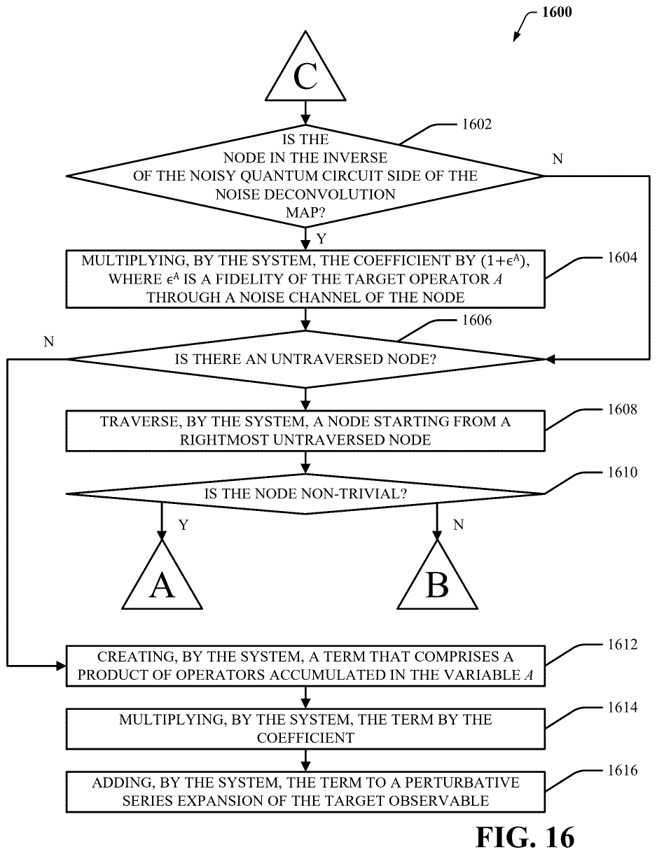

Turning to FIG. 16, in various aspects, act 1602 can include determining, if the node is in the inverse of the noisy quantum circuit side of the noise deconvolution map. If not (e.g., the node is not in the inverse of the noisy quantum circuit side of the noise deconvolution map), the computer-implemented method 1600 can proceed to act 1606. If so (e.g., the node is in the inverse of the noisy quantum circuit side of the noise deconvolution map), the computer-implemented method 1600 can proceed to act 1604.

In various cases, act 1604 can include multiplying, by the system (e.g., via 204), the coefficient by (1+∈^{A}), where ∈^{A} is a fidelity of the A operator through a noise channel of the node. Then, the computer-implemented method 1600 can proceed to act 1606.

In various instances, act 1606 can include determining if there is an untraversed node. If not (e.g., there is not an untraversed node), the computer-implemented method 1600 can proceed to act 1610. If so (e.g., there is an untraversed node), the computer-implemented method 1600 can proceed to act 1606.

In various aspects, act 1608 can include traversing, by the system (e.g., via 204), a node starting from a rightmost untraversed node.

In various embodiments, act 1610 can include determining if the node is non-trivial. If not (e.g., the node is trivial), the computer-implemented method 1600 can proceed to non-limiting computer-implemented method 1500. If so (e.g., the node is non-trivial), the computer-implemented method 1300 can proceed to non-limiting computer-implemented method 1400.

In various aspects, act 1612 can include creating, by the system (e.g., via 204), a term that comprises a product of operators accumulated in the variable. Then, the computer-implemented method 1600 can proceed to act 1614.

In various aspects, act 1614 can include multiplying, by the system (e.g., via 204), the term by the coefficient. Then, the computer-implemented method 1600 can proceed to act 1616.

In various aspects, act 1616 can include adding, by the system (e.g., via 204), the term to a perturbative series expansion (e.g., 210) of the target observable.

FIG. 17 and the following discussion are intended to provide a brief, general description of a suitable computing environment 1700 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1700 contains an example of an environment for the execution of at least some of the computer code involved in performing the inventive methods, such as CPT-based error mitigation code 1728. In addition to block 1728, computing environment 1700 includes, for example, computer 1701, wide area network (WAN) 1702, end user device (EUD) 1703, remote server 1704, public cloud 1705, and private cloud 1706. In this embodiment, computer 1701 includes processor set 1710 (including processing circuitry 1720 and cache 1721), communication fabric 1711, volatile memory 1712, persistent storage 1713 (including operating system 1722 and block 1728, as identified above), peripheral device set 1714 (including user interface (UI), device set 1723, storage 1724, and Internet of Things (IoT) sensor set 1725), and network module 1715. Remote server 1704 includes remote database 1730. Public cloud 1705 includes gateway 1740, cloud orchestration module 1741, host physical machine set 1742, virtual machine set 1743, and container set 1744.

COMPUTER 1701 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1730. As is well understood in the art of computer technology, and depending upon the technology, performance of a computer-implemented method can be distributed among multiple computers or between multiple locations. On the other hand, in this presentation of computing environment 1700, detailed discussion is focused on a single computer, specifically computer 1701, to keep the presentation as simple as possible. Computer 1701 can be located in a cloud, even though it is not shown in a cloud in FIG. 17. On the other hand, computer 1701 is not required to be in a cloud except to any extent as can be affirmatively indicated.

PROCESSOR SET 1710 includes one, or more, computer processors of any type now known or to be developed in the future. Processing circuitry 1720 can be distributed over multiple packages, for example, multiple, coordinated integrated circuit chips. Processing circuitry 1720 can implement multiple processor threads or multiple processor cores. Cache 1721 is memory that is located in the processor chip package(s) and is typically used for data or code that should be available for rapid access by the threads or cores running on processor set 1710. Cache memories are typically organized into multiple levels depending upon relative proximity to the processing circuitry. Alternatively, some, or all, of the cache for the processor set can be located “off chip.” In some computing environments, processor set 1710 can be designed for working with qubits and performing quantum computing.

Computer readable program instructions are typically loaded onto computer 1701 to cause a series of operational steps to be performed by processor set 1710 of computer 1701 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1721 and the other storage media discussed below. The program instructions, and associated data, are accessed by processor set 1710 to control and direct performance of the inventive methods. In computing environment 1700, at least some of the instructions for performing the inventive methods can be stored in block 1728 in persistent storage 1713.

COMMUNICATION FABRIC 1711 is the signal conduction path that allows the various components of computer 1701 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1712 is any type of volatile memory now known or to be developed in the future. Examples include dynamic type random access memory (RAM) or static type RAM. Typically, the volatile memory is characterized by random access, but this is not required unless affirmatively indicated. In computer 1701, the volatile memory 1712 is located in a single package and is internal to computer 1701, but, alternatively or additionally, the volatile memory can be distributed over multiple packages or located externally with respect to computer 1701.

PERSISTENT STORAGE 1713 is any form of non-volatile storage for computers that is now known or to be developed in the future. The non-volatility of this storage means that the stored data is maintained regardless of whether power is being supplied to computer 1701 or directly to persistent storage 1713. Persistent storage 1713 can be a read only memory (ROM), but typically at least a portion of the persistent storage allows writing of data, deletion of data and re-writing of data. Some familiar forms of persistent storage include magnetic disks and solid-state storage devices. Operating system 1722 can take several forms, such as various known proprietary operating systems or open-source Portable Operating System Interface type operating systems that employ a kernel. The code included in block 1728 typically includes at least some of the computer code involved in performing the inventive methods.

PERIPHERAL DEVICE SET 1714 includes the set of peripheral devices of computer 1701. Data communication connections between the peripheral devices and the other components of computer 1701 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1723 can include components such as a display screen, speaker, microphone, wearable devices (such as goggles and smart watches), keyboard, mouse, printer, touchpad, game controllers, and haptic devices. Storage 1724 is external storage, such as an external hard drive, or insertable storage, such as an SD card. Storage 1724 can be persistent or volatile. In some embodiments, storage 1724 can take the form of a quantum computing storage device for storing data in the form of qubits. In embodiments where computer 1701 is required to have a large amount of storage (for example, where computer 1701 locally stores and manages a large database) then this storage can be provided by peripheral storage devices designed for storing large amounts of data, such as a storage area network (SAN) that is shared by multiple, geographically distributed computers. IoT sensor set 1725 is made up of sensors that can be used in Internet of Things applications. For example, one sensor can be a thermometer and another sensor can be a motion detector.

NETWORK MODULE 1715 is the collection of computer software, hardware, and firmware that allows computer 1701 to communicate with other computers through WAN 1702. Network module 1715 can include hardware, such as modems or Wi-Fi signal transceivers, software for packetizing or de-packetizing data for communication network transmission, or web browser software for communicating data over the internet. In some embodiments, network control functions and network forwarding functions of network module 1715 are performed on the same physical hardware device. In other embodiments (for example, embodiments that utilize software-defined networking (SDN)), the control functions and the forwarding functions of network module 1715 are performed on physically separate devices, such that the control functions manage several different network hardware devices. Computer readable program instructions for performing the inventive methods can typically be downloaded to computer 1701 from an external computer or external storage device through a network adapter card or network interface included in network module 1715.

WAN 1702 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1703 is any computer system that is used and controlled by an end user (for example, a customer of an enterprise that operates computer 1701) and can take any of the forms discussed above in connection with computer 1701. EUD 1703 typically receives helpful and useful data from the operations of computer 1701. For example, in a hypothetical case where computer 1701 is designed to provide a recommendation to an end user, this recommendation would typically be communicated from network module 1715 of computer 1701 through WAN 1702 to EUD 1703. In this way, EUD 1703 can display, or otherwise present, the recommendation to an end user. In some embodiments, EUD 1703 can be a client device, such as thin client, heavy client, mainframe computer or desktop computer.

REMOTE SERVER 1704 is any computer system that serves at least some data or functionality to computer 1701. Remote server 1704 can be controlled and used by the same entity that operates computer 1701. Remote server 1704 represents the machine(s) that collect and store helpful and useful data for use by other computers, such as computer 1701. For example, in a hypothetical case where computer 1701 is designed and programmed to provide a recommendation based on historical data, then this historical data can be provided to computer 1701 from remote database 1730 of remote server 1704.

PUBLIC CLOUD 1705 is any computer system available for use by multiple entities that provides on-demand availability of computer system resources or other computer capabilities, especially data storage (cloud storage) and computing power, without direct active management by the scale. The direct and active management of the computing resources of public cloud 1705 is performed by the computer hardware or software of cloud orchestration module 1741. The computing resources provided by public cloud 1705 are typically implemented by virtual computing environments that run on various computers making up the computers of host physical machine set 1742, which is the universe of physical computers in or available to public cloud 1705. The virtual computing environments (VCEs) typically take the form of virtual machines from virtual machine set 1743 or containers from container set 1744. It is understood that these VCEs can be stored as images and can be transferred among and between the various physical machine hosts, either as images or after instantiation of the VCE. Cloud orchestration module 1741 manages the transfer and storage of images, deploys new instantiations of VCEs and manages active instantiations of VCE deployments. Gateway 1740 is the collection of computer software, hardware and firmware allowing public cloud 1705 to communicate through WAN 1702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1706 is similar to public cloud 1705, except that the computing resources are only available for use by a single enterprise. While private cloud 1706 is depicted as being in communication with WAN 1702, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1705 and private cloud 1706 are both part of a larger hybrid cloud.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an expansion component that constructs a perturbative series expansion of a noise deconvolution map of a quantum circuit, wherein the noise deconvolution map is a product of an inverse of the quantum circuit and an ideal realization of the quantum circuit; and
a measurement component that inverts noise on an expectation value of an observable measured on the quantum circuit based on the perturbative series expansion.

2. The system of claim 1, wherein the quantum circuit is compiled in terms of Pauli exponential gates, and wherein the noise deconvolution map is of Pauli or Pauli-Lindblad form.

3. The system of claim 1, wherein the expansion component constructs the perturbative series expansion of the noise deconvolution map using operator backpropogation.

4. The system of claim 1, wherein the expansion component constructs the perturbative series expansion based on a set of Dyson perturbation diagrams, wherein each diagram of the set of Dyson perturbation diagrams corresponds to a term associated with a particular perturbation order.

5. The system of claim 4, wherein the expansion component perturbatively ranks terms in the perturbative series expansion based on a number of orders of sin² θ, wherein θ is an angle associated with an operation, or a number of Pauli operators applied to the observable in the diagram.

6. The system of claim 5, wherein the expansion component truncates the terms in the perturbative series expansion, wherein truncating the terms comprises:
truncating noise terms to a defined perturbative order in noise strength;
truncating the terms up to order of sin^{2k} θ, wherein k denotes a perturbation order; or
truncating the terms based on a Pauli generator order.

7. The system of claim 4, wherein the expansion component maps the term to the diagram, wherein mapping the term to the diagram comprises:
indexing nodes in the ideal realization of the quantum circuit in the noise deconvolution map;
indexing nodes in the inverse of the quantum circuit in the noise deconvolution map symmetrically to the nodes in the ideal realization, wherein each node in the noise deconvolution map represents an operation in the quantum circuit; and
traversing the nodes to determine a coefficient of the term.

8. The system of claim 7, wherein traversing the nodes to determine the coefficient of the term comprises:
scaling the coefficient based on if a generator corresponding to a node anticommutes with a current value of the observable;
scaling the coefficient based on a fidelity of the observable through a noise channel of the node;
scaling the term by the coefficient; and
adding the term to the perturbative series expansion.

9. The system of claim 8, wherein traversing the nodes to determine the coefficient of the term comprises:
identifying if a first node in the ideal realization of the noise-deconvolution map is non-trivial, wherein a non-trivial node is a node that rescales the observable by the generator corresponding to the node;
identifying a second node in the inverse of the quantum circuit of the noise-deconvolution map that is symmetric to the first node, wherein the second node has a same index as the first node; and
removing the generator at the first node and the second node if the first node and second node are non-trivial, subject to commutation relations.

10. The system of claim 8, wherein traversing the nodes to determine the coefficient of the term comprises:
scaling, for trivial nodes where the generator anticommutes with the current value of the observable, the coefficient by cos θ, wherein θ is an angle associated with the operation of the node;
scaling, for non-trivial nodes where the generator anticommutes with the current value of the observable, the coefficient by −i sin θ if the node is in the inverse of the quantum circuit of the noise deconvolution map, or by +i sin θ if the node is in the ideal realization of the noise deconvolution map; and
updating the current value of the observable based on the generator.

11. The system of claim 3, wherein the expansion component expresses the noise deconvolution map in a Clifford interaction picture and iteratively expands the noise deconvolution map to obtain the perturbative series expansion.

12. The system of claim 1, wherein the measurement component measures, on a quantum system, the perturbative series expansion.

13. The system of claim 1, wherein the measurement component measures an expectation value of the perturbative series expansion of the noise deconvolution map based on Pauli-grouping procedures, classical shadows, or generalized quantum measurement protocols of operators in the perturbative series expansion.

14. A computer-implemented method, comprising:
constructing, by a system operatively coupled to a processor, a perturbative series expansion of a noise deconvolution map of a quantum circuit, wherein the noise deconvolution map is a product of an inverse of the quantum circuit and an ideal realization of the quantum circuit; and
inverting noise on an expectation value of an observable measured on the quantum circuit based on the perturbative series expansion.

15. The computer-implemented method of claim 14, wherein the quantum circuit is compiled in terms of Pauli exponential gates, and wherein the noise deconvolution map is of Pauli or Pauli-Lindblad form.

16. The computer-implemented method of claim 14, further comprising:
constructing, by the system, the perturbative series expansion of the noise deconvolution map using operator backpropogation.

17. The computer-implemented method of claim 14, further comprising:
constructing, by the system, the perturbative series expansion based on a set of Dyson perturbation diagrams, wherein each diagram of the set of Dyson perturbation diagrams corresponds to a term associated with a particular perturbation order.

18. The computer-implemented method of claim 17, wherein mapping the term to the diagram comprises:
indexing nodes in the ideal realization of the quantum circuit in the noise deconvolution map;
indexing nodes in the inverse of the quantum circuit in the noise deconvolution map symmetrically to the nodes in the ideal realization, wherein each node in the noise deconvolution map represents an operation in the quantum circuit; and
traversing the nodes to determine a coefficient and an operator of the term.

19. A computer program product for quantum error mitigation, the computer program product comprising a computer readable storage medium having program instructions embodied therewith, the program instructions executable by a processor to cause the processor to:
construct, by the processor, a perturbative series expansion of a noise deconvolution map of a quantum circuit, wherein the noise deconvolution map is a product of an inverse of the quantum circuit and an ideal realization of the quantum circuit; and
invert, by the processor, noise on an expectation value of an observable measured on the quantum circuit based on the perturbative series expansion.

20. The computer program product of claim 19, wherein the program instructions are further executable by the processor to cause the processor to:
construct, by the processor, the perturbative series expansion of the noise deconvolution map based on a set of Dyson perturbation diagrams by mapping a term to a diagram in the set of Dyson perturbation diagrams at a perturbation order.
